(19) United States
(12) Patent Application Publication
(10) Pub. No.: US 2019/0281608 A1
(43) Pub. Date: Sep. 12, 2019

(54) MULTIPLE ACCESS POINT CHANNEL PLANNING

(71) Applicant: QUALCOMM Incorporated, San Diego, CA (US)

(72) Inventors: Xiaolong Huang, San Jose, CA (US); Ahmed Ragab Elsherif, San Jose, CA (US); Srinivas Katar, Fremont, CA (US); Ajay Kumar Pathak, Fremont, CA (US); Manish Shukla, Milpitas, CA (US); Bharat Bhushan, Fremont, CA (US); Ramaswamy Venkateshwaran, Dublin, CA (US)

(21) Appl. No.: 15/917,488

(22) Filed: Mar. 9, 2018

(51) Int. Cl. H04W 72/10; H04W 48/20; H04L 12/733

(52) U.S. Cl. CPC H04W 72/10; H04B 7/185; H04L 45/20; H04W 48/20

(57) ABSTRACT

This disclosure provides systems, methods and apparatuses for channel selection and channel selection planning in a network including a root AP (RAP) and a number of satellite APs (SAPs). The root AP may assign operating channels for one or more of the satellite APs in a manner that optimizes network performance by considering the impact that each of the satellite APs (as well as their respective client devices) may have on the network. In some implementations, the root AP may provide centralized channel selection planning for the network based a number of network parameters observed by one or more of the satellite APs. The network parameters may include, for example, channel conditions, traffic loads, traffic patterns, service needs of client devices, available channels, and other network utilization information observed by one or more of the satellite APs.

### TECHNICAL FIELD

This disclosure relates generally to wireless networks, and specifically to planning channel allocations in a wireless network having multiple access points.

### DESCRIPTION OF THE RELATED TECHNOLOGY

A wireless local area network (WLAN) may be formed by one or more access points (APs) that provide a shared wireless medium for use by a number of client devices. Each AP, which may correspond to a Basic Service Set (BSS), periodically broadcasts beacon frames to enable compatible client devices within wireless range of the AP to establish and maintain a communication link with the WLAN. A plurality of APs may be connected together to form an extended BSS. WLANs that operate in accordance with the IEEE 802.11 family of standards are commonly referred to as Wi-Fi networks, and client devices that communicate with the AP in a Wi-Fi network may be referred to as wireless stations (STAs). Many APs and STAs are capable of operating on a number of different frequency bands including, for example, the 2.4 GHz frequency band, the 5 GHz frequency band, and the 60 GHz frequency band.

A plurality of APs may be connected together to form an extended BSS (ESS). For example, many office and home wireless networks configured to operate as an ESS may include a root AP and a number of satellite APs such as relay or repeater APs. In some deployments, the root AP may provide a back-haul connection to other networks (such as the Internet), and the repeater APs may extend the effective wireless coverage area of the root AP. To reduce co-channel interference with each other, one or more of the root AP and the repeater APs may avoid transmitting and receiving data on the same channel. For example, an AP may avoid co-channel interference by selecting an operating channel that is not currently used by other nearby APs. The limited number of available channels within a given frequency band may undesirably restrict an AP's ability to avoid co-channel interference.

### SUMMARY

The systems, methods and devices of this disclosure each have several innovative aspects, no single one of which is solely responsible for the desirable attributes disclosed herein.

One innovative aspect of the subject matter described in this disclosure can be implemented in a wireless network to perform a channel selection operation for a selected access point (AP). The method may include estimating a usage level of each of a set of available channels of the selected AP, determining a score for each of the available channels, selecting the channel having the highest score, and allocating the channel having the highest score as the operating channel to the selected AP. In some implementations, the score for a respective channel is based on at least one of a preference level of the respective channel, a bandwidth of the respective channel, or the estimated usage level of the respective channel.

In some implementations, the usage level of a respective channel may be estimated by initializing the estimated usage level of the respective channel to zero, identifying operating channels of each of a number of neighboring APs of the selected AP, determining which of the neighboring APs uses an operating channel that overlaps the respective channel, and increasing the estimated usage level of the respective channel by a first amount based on the number of neighboring APs determined to use an overlapping channel.

Another innovative aspect of the subject matter described in this disclosure can be implemented in a wireless network to perform a channel selection operation for a network including a root access point (AP) and a plurality of satellite APs. The method may include dividing the satellite APs into a number of groups based on a number of hops to the root AP, initializing an estimated usage level of each of a set of available channels of the satellite APs to zero, ordering the groups of satellite APs based on increasing numbers of hops to the root AP, and iteratively performing a channel selection operation on each group of satellite APs based on the ordering. In some implementations, the channel selection operation may be performed on groups of satellite APs having fewer numbers of hops to the root AP before groups of satellite APs having greater numbers of hops to the root AP.

In some implementations, iteratively performing the channel selection operation may include identifying the group of satellite APs having the fewest number of hops to the root AP, selecting one of the satellite APs within the identified group, determining an estimated usage level of each of the available channels of the selected satellite AP, determining a score for each of the available channels of the selected satellite AP, selecting the channel having the highest score, and allocating the channel having the highest score as the operating channel of the selected satellite AP. In some implementations, performing the virtual channel selection plan assessment may include initializing a maximum airtime fraction of each satellite AP to a value, performing a network-wise scheduling operation that assigns airtime to each satellite AP based on traffic demands of their client devices, and setting a network capacity equal to a value corresponding to an airtime utilization determined for the root AP.

Another innovative aspect of the subject matter described in this disclosure can be implemented in a wireless network to perform a channel selection operation for a network including a root access point (AP) and a plurality of satellite APs. The method may include determining a score for each of the satellite APs in a group of APs, identifying a number of the satellite APs in the group that have the highest scores, performing a channel selection operation for the remainder of the APs in the network, determining a network capacity of each of the number of satellite APs using a virtual channel selection plan operation, selecting the satellite AP having the highest network capacity, determining an estimated usage level of each of the available channels of the selected satellite AP, determining a score for each of the available channels of the selected satellite AP, identifying a number of channels having the highest scores, and determining a network capacity of each of the number of identified channels using the virtual channel selection plan operation. In some implementations, performing the virtual channel selection plan assessment may include initializing a maximum airtime fraction of each satellite AP to a value, performing a network-wise scheduling operation that assigns airtime to each satellite AP based on traffic demands of their client devices, and setting a network capacity equal to a value corresponding to an airtime utilization determined for the root AP.

Another innovative aspect of the subject matter described in this disclosure can be implemented in a root access point (AP). The root AP may perform a channel selection operation for a network including a plurality of satellite APs. In some implementations, the root AP may include one or more processors and a memory. The memory can store instructions that, when executed by the one or more processors, cause the root AP to divide the satellite APs into a number of groups based on a number of hops to the root AP, initialize an estimated usage level of each of a set of available channels of the satellite APs to zero, order the groups of satellite APs based on increasing numbers of hops to the root AP, and iteratively perform a channel selection operation on each group of satellite APs based on the ordering. In some implementations, the root AP may iteratively perform the channel selection operation by identifying the group of satellite APs having the fewest number of hops to the root AP, selecting one of the satellite APs within the identified group, determining an estimated usage level of each of the available channels of the selected satellite AP, determining a score for each of the available channels of the selected satellite AP, selecting the channel having the highest score, and allocating the channel having the highest score as the operating channel of the selected satellite AP. In some implementations, the score for a respective channel may be based on at least one of a preference level of the respective channel, a bandwidth of the respective channel, or the estimated usage level of the respective channel.

Execution of the instructions may also cause the root AP to perform a virtual channel selection plan assessment for the network. In some implementations, the root AP may perform the virtual channel selection plan assessment by initializing a maximum airtime fraction of each satellite AP to a value, performing a network-wise scheduling operation that assigns airtime to each satellite AP based on traffic demands of their client devices, and setting a network capacity equal to a value corresponding to an airtime utilization determined for the root AP.

### BRIEF DESCRIPTION OF THE DRAWINGS

FIG. 1 shows an example wireless network.

FIG. 2 is an illustration depicting example wireless coverage areas of the access points (APs) of FIG. 1.

FIG. 3 shows a block diagram of an example access point.

FIG. 4 shows a flow chart depicting an example algorithm for performing a channel selection operation.

FIGS. 5A-5D show example message flow diagrams associated with a channel selection operation.

FIG. 6 shows an example message for sharing channel condition information.

FIG. 7 shows a flow chart depicting an example algorithm for performing a channel usage estimation operation.

FIG. 8 shows a flow chart depicting an example algorithm for performing a channel selection operation for an AP.

FIG. 9 shows a flow chart depicting an example algorithm for performing a channel selection operation for a network without a channel selection plan assessment.

FIG. 10 shows a flow chart depicting an example algorithm for performing an iterative channel selection operation.

FIG. 11 shows a flow chart depicting an example algorithm for performing a channel selection operation for a network with a virtual channel selection plan assessment.

FIG. 12 shows a flow chart depicting an example algorithm for performing a virtual channel selection plan assessment.

FIG. 13 shows a flow chart depicting an example algorithm for performing a channel selection operation with virtual channel selection plan assessment and real-time channel selection plan assessment.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, system or network that is capable of transmitting and receiving RF signals according to any of the IEEE 802.11 standards, the Bluetooth® specification, and cellular communication protocols such as (but not limited to) code division multiple access (CDMA), frequency division multiple access (FDMA), time division multiple access (TDMA), Global System for Mobile communications (GSM), GSM/General Packet Radio Service (GPRS), and Enhanced Data GSM Environment (EDGE), or other known signals that are used to communicate within a wireless, cellular or internet of things (IOT) network, such as a system utilizing 3G, 4G or 5G, or further implementations thereof, technology.

Channel selection is a mechanism through which an AP may select an operating channel for its wireless coverage area. In some implementations, the AP may select its operating channel from a set of available channels associated with one or more frequency bands supported by the AP. In a wireless network including multiple APs that may have overlapping wireless coverage areas, it is desirable to coordinate the selection of operating channels used by nearby APs to minimize co-channel interference between nearby APs. In some aspects, nearby APs may use the same operating channel if the co-channel interference is below a value (such that interference between the nearby APs is minimal or is at least acceptable). In other aspects, nearby APs may not use the same operating channel if the co-channel interference is above a value (such that interference between the nearby APs degrades performance or is unacceptable).

Implementations of the subject matter described in this disclosure can be used to perform a centralized channel selection operation that assigns operating channels to a plurality of APs in a network in a manner that minimizes co-channel interference between nearby APs in the network. The centralized channel selection operation may be used to generate a channel selection plan that accounts for some or all of the traffic patterns in the network, the capacities of all the APs in the network, the service needs of all client devices in the network, and the capacities of all the available channels in the network. In this manner, operating channels may be allocated to all of the APs in a network in a manner that considers the impact of each of the APs.

In the following description, numerous specific details are set forth such as examples of specific components, circuits, and processes to provide a thorough understanding of the present disclosure. The term “associated AP” refers to an AP with which a given STA is associated (e.g., there is an established communication channel or link between the AP and the given STA). The term “non-associated AP” refers to an AP with which a given STA is not associated (e.g., there is not an established communication channel or link between the AP and the given STA, and thus the AP and the given STA may not yet exchange data frames). The non-associated APs may also be referred to herein as “candidate APs,” and thus the terms “non-associated AP” and “candidate AP” may be used interchangeably herein.

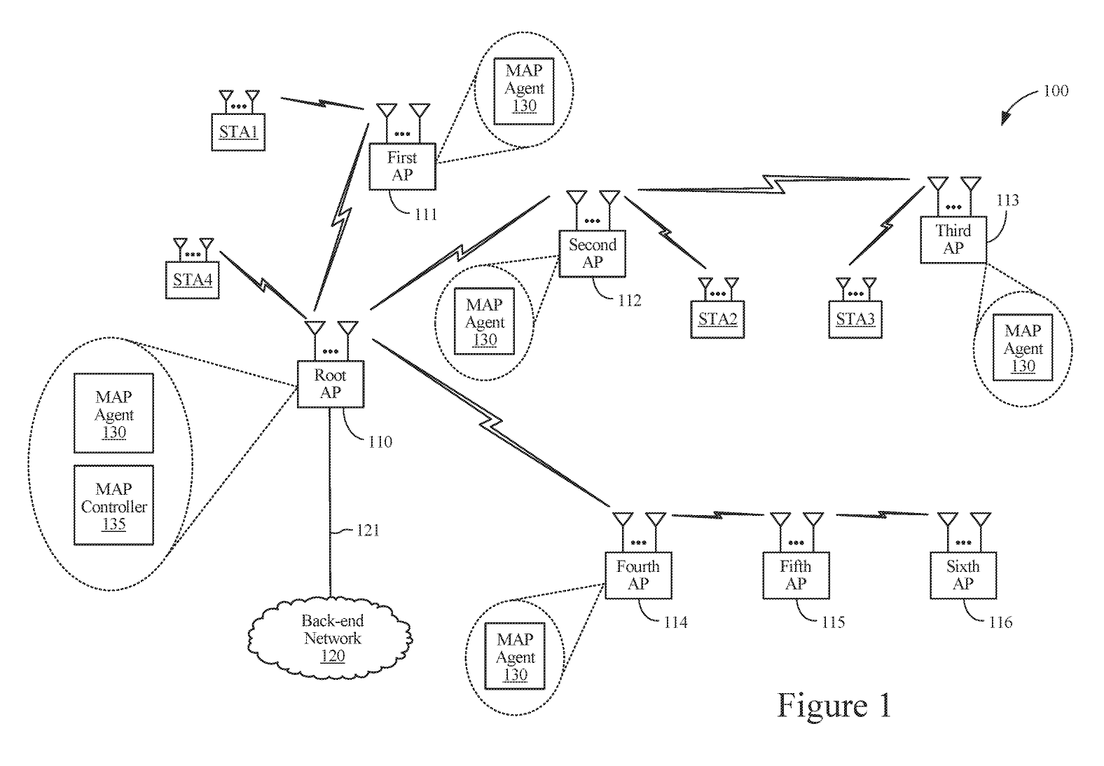

FIG. 1 shows a block diagram of an example wireless system 100. The wireless system 100 is shown to include a number of wireless access points (APs) 110-116 and a number of wireless stations (STAs) STA1-STA4. The APs 110-116 may form a wireless local area network (WLAN) that allows the APs 110-116, the stations STA1-STA4, and other wireless devices (not shown for simplicity) to communicate with each other over a wireless medium. The wireless medium may be divided into a number of channels, may be divided into a number of resource units (RUs), or both. The APs 110-116 may each include an assigned unique MAC address that is programmed therein by, for example, the manufacturer of the access point. Similarly, each of the stations STA1-STA4 also may be assigned a unique MAC address. In some implementations, the wireless system 100 may correspond to a multiple-input multiple-output (MIMO) wireless network, and may support single-user MIMO (SU-MIMO) and multi-user (MU-MIMO) communications. In some implementations, the wireless system 100 may support orthogonal frequency-division multiple access (OFDMA) communications.

The stations STA1-STA4 may be any suitable Wi-Fi enabled wireless devices including, for example, cell phones, personal digital assistants (PDAs), tablet devices, laptop computers, or the like. The stations STA1-STA4 also may be referred to as a user equipment (UE), a subscriber station, a mobile station, a mobile subscriber station, a mobile unit, a subscriber unit, a wireless unit, a remote unit, a mobile device, a wireless device, a wireless communications device, a remote device, an access terminal, a mobile terminal, a wireless terminal, a remote terminal, a handset, a user agent, a mobile client, a client, or some other suitable terminology.

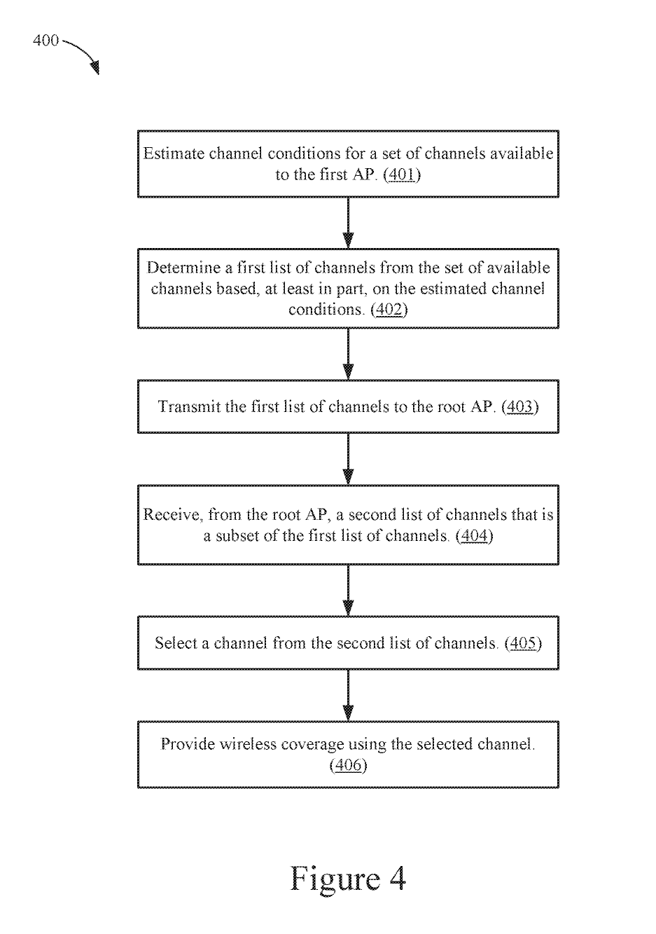

The APs 110-116 may be any suitable device that allows one or more wireless devices (such as the stations STA1-STA4) to connect to another network (such as a local area network (LAN), wide area network (WAN), metropolitan area network (MAN), or the Internet). In some implementations, each of the stations STA1-STA4 and each of the APs 110-116 may include one or more transceivers, one or more processing resources (such as processors or ASICs), one or more memory resources, and a power source (such as a battery for the stations STA1-STA4). The one or more transceivers may include Wi-Fi transceivers, Bluetooth transceivers, cellular transceivers, or other suitable radio frequency (RF) transceivers (not shown for simplicity) to transmit and receive wireless communication signals. In some implementations, each transceiver may communicate with other wireless devices in distinct frequency bands or using distinct communication protocols. The memory resources may include a non-transitory computer-readable medium (such as one or more nonvolatile memory elements, such as EPROM, EEPROM, Flash memory, a hard drive, etc.) that stores instructions for performing one or more operations described below with respect to FIGS. 4, 5A-5D, and 7-13.

In some implementations, each of the APs 110-116 may periodically broadcast beacon frames to enable the stations STA1-STA4 and other wireless devices within their wireless ranges to establish and maintain a communication link with the respective one of the APs 110-116. The beacon frames, which are typically broadcast according to a target beacon transmission time (TBTT) schedule, may include timing synchronization function (TSF) values of one or more of the APs 110-116. The stations STA1-STA4 may synchronize their own local TSF values with the broadcast TSF values, for example, so that all the stations STA1-STA4 are synchronized with each other and with the APs 110-116. In some aspects, the beacon frames may indicate downlink (DL) data transmissions to the stations STA1-STA4, and may solicit or schedule uplink (UL) data transmissions from the stations STA1-STA4.

In some implementations, the AP 110 may operate as a root AP (RAP), and each of the APs 111-116 may operate as satellite APs (SAPs). In such implementations, the AP 110 may be referred to as the root AP 110, and each of the APs 111-116 may be referred to as a satellite AP (SAP). The root AP 110 may facilitate communications between the root AP 110 and the satellite APs 111-116, and may also facilitate communications between the WLAN and other networks or systems. In some aspects, the root AP 110 may be connected via a wired connection 121 (or alternatively via a wireless connection) to a back-end network 120 such as, for example, a local area network (LAN), wide area network (WAN), metropolitan area network (MAN), the Internet, or any combination thereof. The root AP 110 may be connected to each of the satellite APs 111-116 via either a wireless connection or a wired connection (not shown for simplicity).

In some implementations, the root AP 110 may be or may include a multi-AP (MAP) agent 130 and a MAP controller 135. The MAP agent 130 may allow the root AP 110 to provide wireless services to a number of client devices (such as the stations STA1-STA4) and to communicate with one or more of the APs 111-116. The MAP controller 135 may coordinate channel planning for the APs 110-116 and their associated client devices, and may configure one or more aspects of the downstream APs 111-116. In some implementations, the root AP 110 may use the MAP controller 135 to steer one more of the stations STA1-STA4 to other APs or may steer one more of the APs 111-116 to other frequency bands (or both) based on a number of factors that may include, for example, changes in load balance on the APs 110-116, changes in traffic patterns of the network, changes in locations of the stations STA1-STA4, changes in bandwidth or service needs of the stations STA1-STA4, changes in channel conditions, changes in operating channels, changes in capacities of the APs 110-116, changes in available airtime for the APs 110-116, or any combination thereof. In addition, or in the alternative, the root AP 110 may use the MAP controller 135 to generate one or more channel selection plans for the network. The channel selection plans may be used to dynamically assign operating channels to the APs 111-116 in a manner that considers the impact that each of the APs 111-116 (as well as their respective client devices) may have on the network, thereby optimizing network performance.

Although depicted in the example of FIG. 1 as being part of the root AP 110, the MAP controller 135 may be separate from the root AP 110. In other implementations, the root AP 110 may include the MAP controller 135 but may not include the MAP agent 130 (and may not provide wireless service to client devices such as the stations STA1-STA4).

Each of the satellite APs 111-116 may be or may include a MAP agent 130 that allows the satellite APs 111-116 to provide wireless services to a number of client devices (such as the stations STA1-STA4). The MAP agents 130 may also allow their corresponding satellite APs 111-116 to communicate with downstream satellite APs or with upstream satellite APs (or both). In some implementations, the satellite APs 111-116 may be used to extend the wireless coverage area of the root AP 110, for example, by operating as relay devices or range extender devices. In the example of FIG. 1, the root AP 110 and the satellite APs 111-116 are arranged in a tree topology in which the root AP 110 provides a connection between the WLAN and the back-end network 120, and the satellite APs 111-116 form various branches of the tree topology. For example, the first AP 111 forms a first branch of the tree topology, the second and third APs 112-113 form a second branch of the tree topology, and the fourth, fifth, and sixth APs 114-116 form a third branch of the tree topology. The first, second, and fourth APs 111,112, and 114 are directly connected to the root AP 110, and therefore may be classified as 1-hop devices of the network. The third and fifth APs 113 and 115 are connected to the root AP 110 by intervening APs 112 and 114, respectively, and therefore may be classified as 2-hop devices of the network. The sixth AP 116 is connected to the root AP 110 by intervening APs 114 and 115, and therefore may be classified as a 3-hop device of the network.

For the example system 100 of FIG. 1, the first station STA1 is currently associated with the first AP 111, the second station STA2 is currently associated with the second AP 112, the third station STA3 is currently associated with the third AP 113, and the fourth station STA4 is currently associated with the root AP 110. In some implementations, each of the root AP 110 and the satellite APs 111-116 may define its own Basic Service Set (BSS), and all client devices associated with a given AP may be included within the given AP's BSS. In other implementations, the root AP 110 and a group of the satellite APs 111-116 may form an Extended Basic Services Set (ESS), and all client devices associated with the root AP 110 and the group of the satellite APs 111-116 may be included within the ESS.

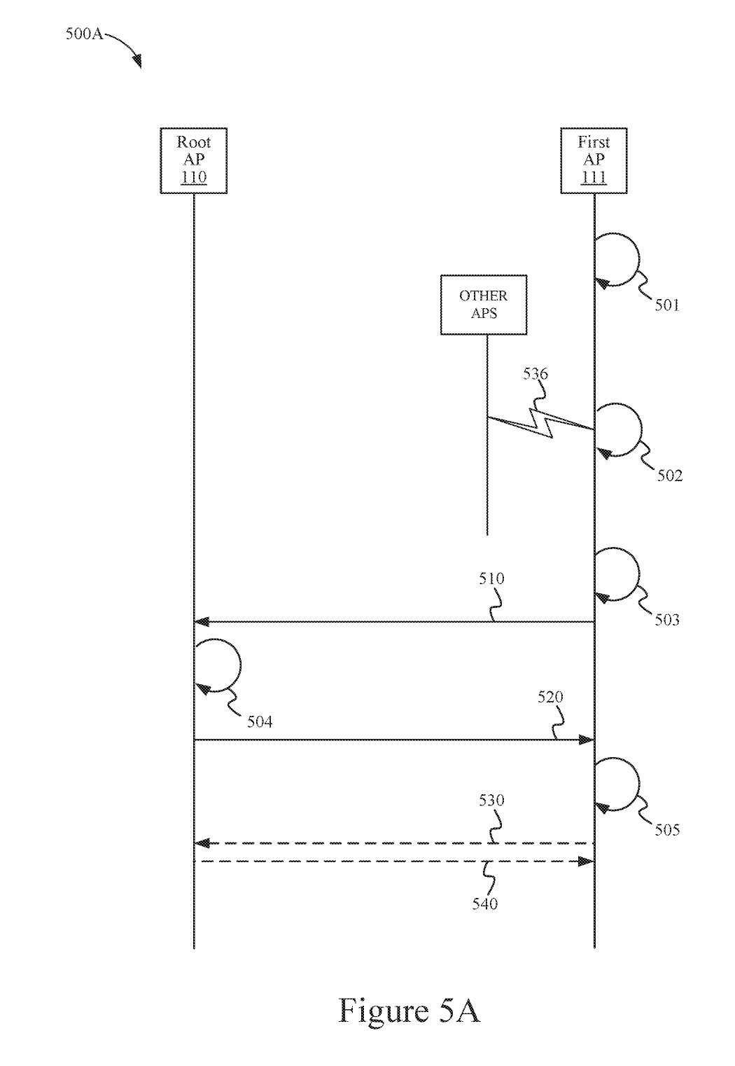

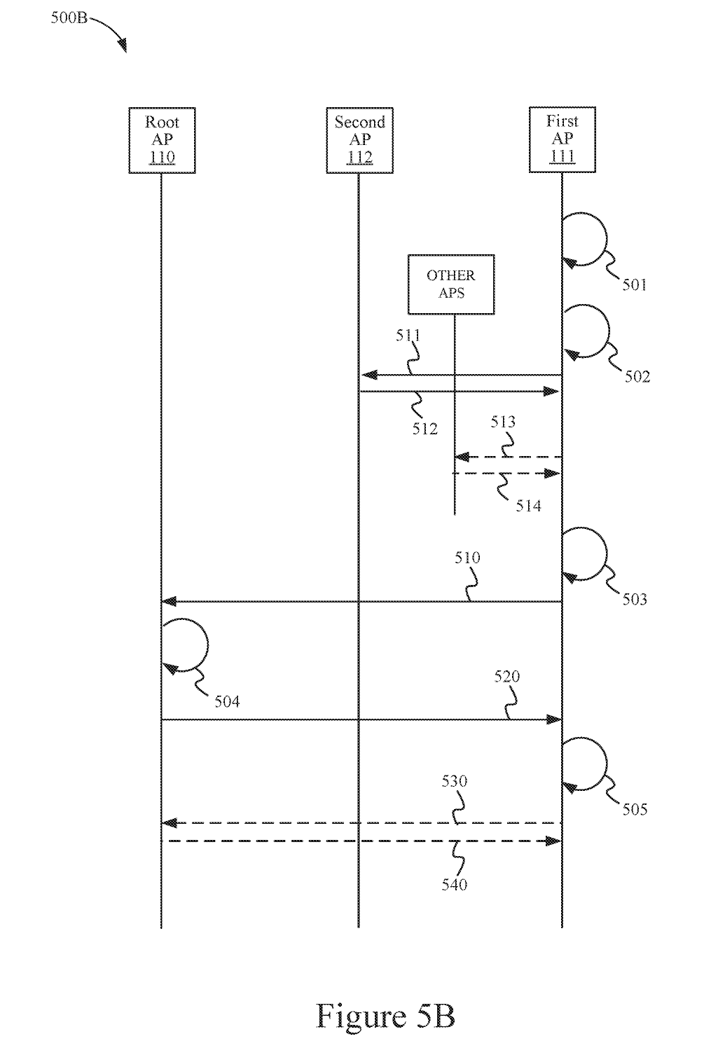

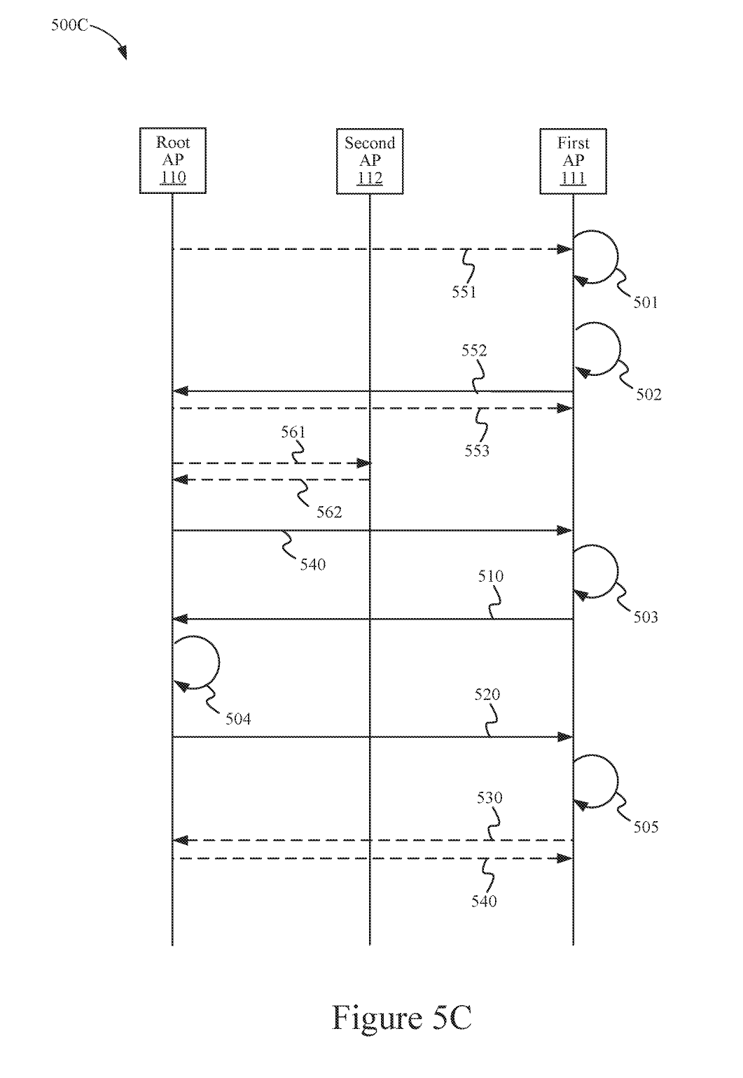

The MAP controller 135 may be used to assign operating channels for the root AP 110 and for one or more of the satellite APs 111-116 in a manner that optimizes network performance by considering the impact that each of the satellite APs 111-116 (as well as their respective client devices) may have on the network. In some implementations, the MAP controller 135 may provide centralized channel selection planning for the network based a number of network parameters observed by one or more of the satellite APs 111-116. The network parameters may include, for example, channel conditions, traffic loads, traffic patterns, service needs of client devices, available channels, and other network utilization information observed by one or more of the satellite APs 111-116. In some aspects, the satellite APs 111-116 may determine one or more network parameters and transmit the determined network parameters to the root AP 110, for example, as described with respect to FIG. 4 and FIGS. 5A-5D.

The MAP controller 135 may collect the determined network parameters from the satellite APs 111-116 and use the determined network parameters to generate one or more channel selection plans for the network. In some implementations, the MAP controller 135 may determine a score for each of the channel selection plans and may deploy the channel selection plan having the highest score across the network. The deployed channel selection plan may be used to allocate operating channels to the root AP 110 and the satellite APs 111-116. In some aspects, the deployed channel selection plan may alter the channel allocations to one or more of the root AP 110 and the satellite APs 111-116 based on times of the day, days of the week, and other suitable factors.

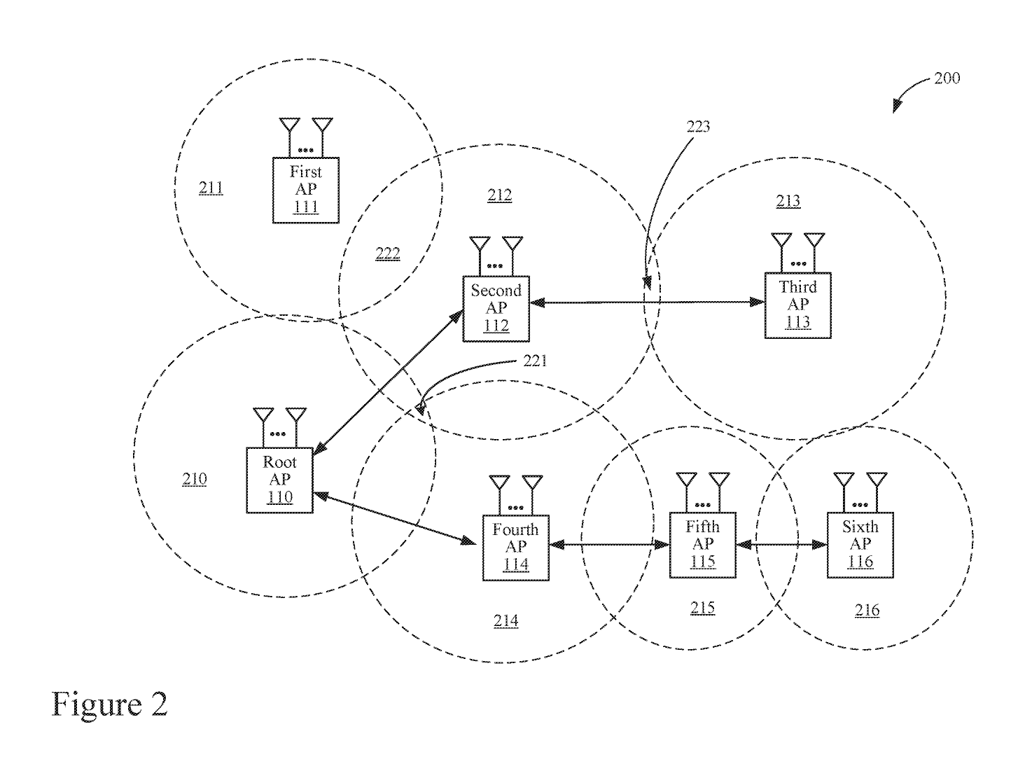

FIG. 2 is an illustration 200 depicting example wireless coverage areas of the APs 110-116 of FIG. 1. For simplicity, the stations STA1-STA4 and the back-end network 120 are not shown in FIG. 2. The wireless coverage area provided by an AP may refer to a physical area in which the AP can exchange wireless signals with one or more other devices on a wireless medium. Each AP may not provide uniform wireless coverage within an environment, and the wireless coverage areas of nearby APs may be different due to many factors including, for example, wireless signal power levels, capabilities of the stations STA1-STA4, capabilities of the APs, frequency propagation, radio frequency (RF) interference, terrain, reflections, and so on. In addition, different wireless channels may be associated with different wireless coverage areas based on the environment or other APs in the network.

In the example of FIG. 2, the root AP 110 provides a root wireless coverage area 210, the first AP 111 provides a first wireless coverage area 211, the second AP 112 provides a second wireless coverage area 212, the third AP 113 provides a third wireless coverage area 213, the fourth AP 114 provides a fourth wireless coverage area 214, the fifth AP 115 provides a fifth wireless coverage area 215, and the sixth AP 116 provides a sixth wireless coverage area 216. As shown in FIG. 2, some of the wireless coverage areas 210-216 may overlap each other. For example, the root wireless coverage area 210, the second wireless coverage area 212, and the fourth wireless coverage area 214 overlap each other in a first region 221; the first wireless coverage area 211 and the second wireless coverage area 212 overlap each other (but not the root wireless coverage area 210) in a second region 222; the second wireless coverage area 212 and the third wireless coverage area 213 overlap each other (but not the root wireless coverage area 210 or the first wireless coverage area 211) in a third region 223, and so on. In some implementations, the root AP 110 may cause or instruct a number of the APs 111-116 to operate on different operating channels to minimize channel degradation in one or more of the overlapping regions 221-226. For example, if the first wireless coverage area 211 uses a first channel and the second wireless coverage area 212 uses a second channel different than the first channel, then the degradation of the effective channel capacity of each of the first and second channels resulting from the overlapping region 222 may be reduced.

In addition, or in the alternative, the root AP 110 may cause or instruct a number of the satellite APs 111-116 to operate on different operating channels to prevent channel reuse in one or more of the overlapping regions 221-226. For example, because the overlapping region 221 includes a portion of the first wireless coverage area 212, a portion of the second wireless coverage area 211, and a portion of the root wireless coverage area 210, channel degradation in the overlapping region 221 may be minimized if the root AP 110, the first AP 111, and the second AP 112 operate on different channels.

Each of the APs 110-116 may be capable of scanning for a set of channels within a selected frequency band. However, without considering the impact of channel selection with respect to other APs, a channel selection by one AP may inadvertently impact the wireless coverage provided by another AP. For example, if the first AP 111 selects a channel for the first wireless coverage area 211 based only on channel conditions observed by itself, then network traffic and loading on that channel by neighboring APs 110 and 112 may result in the selected channel having lower capacity than estimated by the first AP 111. More specifically, a channel selected by the first AP 111 may appear to be unutilized (or underutilized) in a wireless scan performed by the first AP 111. However, the same channel may appear to be heavily loaded (or incur significant interference) at the second AP 112 (possibly from a different network that is also operating within a coverage area of the second AP 112). The second AP 112 can be impacted in multiple ways depending on how it is utilizing its radios. For example, if the second AP 112 is using that channel for a backhaul channel from the second AP 112 to the first AP 111, then the second AP 112 may see higher packet errors for the backhaul channel due to a neighboring interferer that is unseen by the first AP 111. In another example, if the second AP 112 is using the channel for both backhaul and BSS service links, then the second AP 112 may also be constrained in the amount of traffic it can serve in its BSS (since the second AP 112 would be contending with the neighbor AP, even though the neighbor AP is unseen by the first AP 111).

Thus, when selecting a channel, the first AP 111 may benefit from obtaining channel condition information that is observable by other APs in the network (even if some of the channel conditions are not directly observable by the first AP 111). Furthermore, by coordinating enhanced channel selection between the first AP 111 and the root AP 110, the root AP 110 may select a better channel to maximize channel reuse within the network, such as when overlapping coverage areas are unavoidable. Maximizing channel reuse may improve the overall network capacity.

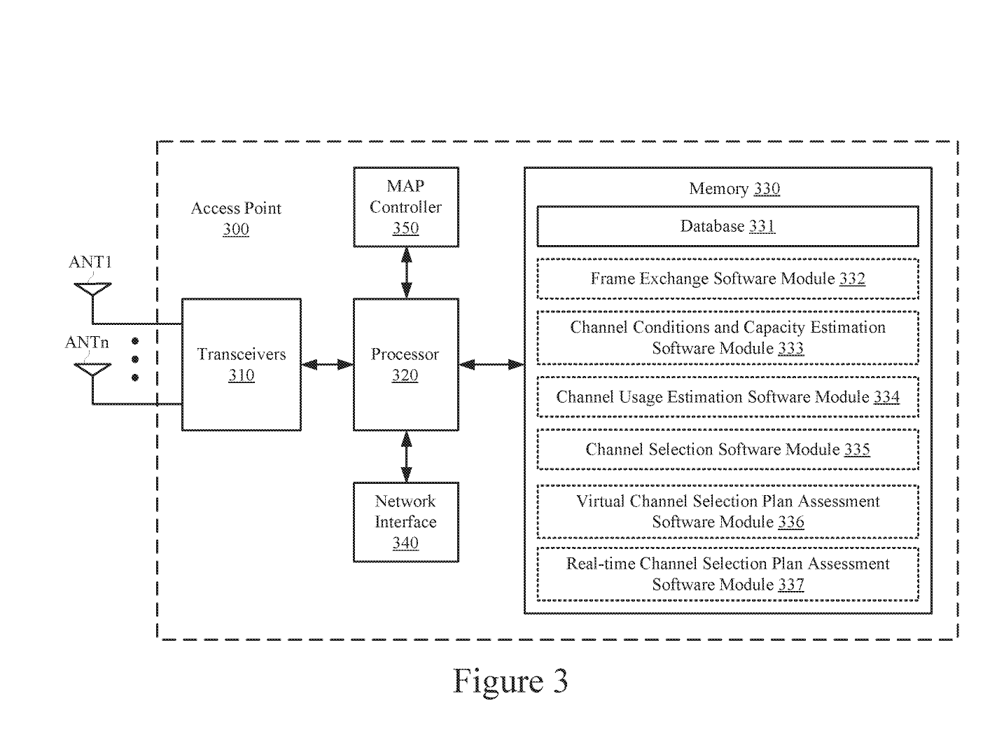

FIG. 3 shows an example access point (AP) 300. The AP 300 may be one implementation of the root AP 110 of FIG. 1, may be one implementation of the APs 111-116 of FIG. 1, or both. The AP 300 may include one or more transceivers 310, a processor 320, a memory 330, a network interface 340, a MAP controller 350, and a number of antennas ANT1-ANTn. The transceivers 310 may be coupled to the antennas ANT1-ANTn, either directly or through an antenna selection circuit (not shown for simplicity). The transceivers 310 may be used to transmit signals to and receive signals from other wireless devices including, for example, one or more of the stations STA1-STA4 of FIG. 1 and other APs. Although not shown in FIG. 3 for simplicity, the transceivers 310 may include any number of transmit chains to process and transmit signals to other wireless devices via the antennas ANT1-ANTn, and may include any number of receive chains to process signals received from the antennas ANT1-ANTn. Thus, the AP 300 may be configured for MIMO communications and OFDMA communications. The MIMO communications may include SU-MIMO communications and MU-MIMO communications. In some implementations, the wireless device 300 may use multiple antennas ANT1-ANTn to provide antenna diversity. Antenna diversity may include polarization diversity, pattern diversity, and spatial diversity.

The network interface 340, which is coupled to the processor 320, may be used to communicate with the back-end network 120 of FIG. 1. The network interface 340 also may allow the AP 300 to communicate, either directly or via one or more intervening networks, with other wireless systems, with other APs, and so on.

The memory 330 may include a database 331 that may store location data, configuration information, data rates, MAC addresses, timing information, modulation and coding schemes, preferred channels, ranging capabilities, and other suitable information about (or pertaining to) a number of other wireless devices. The database 331 also may store profile information for a number of other wireless devices. The profile information for a given wireless device may include, for example, the wireless device's service set identification (SSID), BSSID, operating channels, TSF values, beacon intervals, ranging schedules, channel state information (CSI), received signal strength indicator (RSSI) values, goodput values, connection history with the AP 300, and previous ranging operations with the AP 300.

The memory 330 also may include a non-transitory computer-readable storage medium (such as one or more nonvolatile memory elements, such as EPROM, EEPROM, Flash memory, a hard drive, and so on) that may store the following software modules:
a frame exchange software module 332 to create and exchange a number of frames (such as data frames, control frames, management frames, and action frames) between the AP 300 and other wireless devices, for example, as described with respect to FIGS. 4, 5A-5D, and 7-13;
a channel conditions and capacity estimation software module 333 to estimate channel conditions and capacities of a number of wireless channels, to estimate available bandwidth and load information of a number of wireless devices, to estimate available airtime of wireless devices, or any combination thereof, for example, as described with respect to FIGS. 4, 5A-5D, and 7-13;
a channel usage estimation software module 334 to estimate a usage level of each of a number of available channels, for example, as described with respect to FIGS. 4, 5A-5D, and 7-13;
a channel selection software module 335 to perform a number of channel selection operations to allocate operating channels to one or more APs within a network, for example, as described with respect to FIGS. 4, 5A-5D, and 7-13;
a virtual channel selection plan assessment software module 336 to assess, using virtual techniques or simulations, various network conditions to aid in the selection of operating channels for one or more APs in a network, for example, as described with respect to FIGS. 4, 5A-5D, and 7-13; and
a real-time selection plan assessment software module 337 to assess, in real-time, various network conditions to aid in the selection of operating channels for one or more APs in a network, for example, as described with respect to FIGS. 4, 5A-5D, and 7-13.

Each software module includes instructions that, when executed by the processor 320, may cause the AP 300 to perform the corresponding functions. The non-transitory computer-readable medium of the memory 330 thus includes instructions for performing all or a portion of the operations described below with respect to FIGS. 4, 5A-5D, and 7-13.

The processor 320 may be any one or more suitable processors capable of executing scripts or instructions of one or more software programs stored in the AP 300 (such as within the memory 330). The processor 320 may execute the frame exchange software module 332 to create and exchange a number of frames (such as data frames, control frames, management frames, and action frames) between the AP 300 and other wireless devices.

The processor 320 may execute the channel conditions and capacity estimation software module 333 to estimate channel conditions and capacities of a number of wireless channels, to estimate available bandwidth and load information of a number of wireless devices, to estimate available airtime of wireless devices, or any combination thereof. The processor 320 may execute the channel usage estimation software module 334 to estimate a usage level of each of a number of available channels. The processor 320 may execute the channel selection software module 335 to perform a number of channel selection operations to allocate operating channels to one or more APs within a network.

The processor 320 may execute the virtual channel selection plan assessment software module 336 to assess, using virtual techniques or simulations, various network conditions to aid in the selection of operating channels for one or more APs in a network. The processor 320 may execute the real-time selection plan assessment software module 337 to assess, in real-time, various network conditions to aid in the selection of operating channels for one or more APs in a network.

The MAP controller 350 may be coupled to the processor 320 and to the memory 330. In some implementations, the MAP controller 350 may be one example of the MAP controller 135 of FIG. 1. In addition, or in the alternative, the MAP controller 350 may be implemented as a software program or module including instructions stored in the memory 330 for execution by the processor 320, and may be used to perform one or more of the operations described with respect to FIGS. 4, 5A-5D, and 7-13.

FIG. 4 shows a flow chart depicting an example algorithm for performing an enhanced channel selection operation 400. Although described herein with respect to the first AP 111 of FIG. 1, the example operation 400 may be performed by any of the APs 110-1116 of FIG. 1 (or any other suitable wireless device). Referring also to FIG. 2, the first AP 111 may estimate (or otherwise obtain) channel conditions for a set of channels available to the first AP 111 (401). For example, the first AP 111 may scan the set of channels and may estimate channel conditions based on factors observable to the first AP 111. Alternatively, or additionally, the first AP 111 may send a query message to at least a second AP (and possibly one or more other APs) in the network, and receive a response message from the second AP (and possibly the one or more other APs). The response message may include at least a portion of the estimated channel conditions. In some implementations, the first AP 111 may send a query message to the root AP 110 in the network, and receive a response message from the root AP 110. The response message from the root AP 110 may include channel conditions for the second AP 112 (and possibly for one or more other APs). In some implementations, the estimated channel conditions may include estimated channel conditions for a second channel used by the second AP 112, and may include estimated channel conditions for channels detected by the second AP 112.

The first AP 111 may determine a first list of channels from the set of available channels based, at least in part, on the estimated channel conditions (402). In some implementations, the first AP 111 may rank the set of available channels based, at least in part, on the estimated channel conditions, and select the first list of channels based on the ranking. In some aspects, the first AP 111 may, for each of the available channels, determine its effective channel capacity, determine an estimated load impact to a neighbor AP that is already using the channel, determine a probability of triggering a remote channel switch trigger condition of the neighbor AP that would result from the first AP 111 selecting the channel, or any combination thereof. In addition, or in the alternative, the first AP 111 may generate a score for each available channel based on the effective channel capacity, the estimated load impact, the probability of triggering a remote channel switch trigger condition, or any combination thereof. The scores for a plurality of available channels may be used to rank or order the available channels. In some implementations, the first list of channels may include the higher ranked channels from the plurality of available channels (such as a number n of the highest ranked channels).

In some implementations, the channel selection operation 400 may be used to determine a channel size within a frequency band that supports different channel sizes. For example, the first AP 111 may be capable of utilizing a 20 MHz, 40 MHz, 80 MHz, or other channel size within a frequency band (such as the 5.0 GHz frequency band defined in the IEEE 802.11 standards). The first list of channels may include a ranked (in order of preference) listing of channels even though the channels in the list may be of different channel sizes.

The first AP 111 may transmit the first list of channels to the root AP 110 (403). The root AP 110 may distill the first list of channels based on considering how each available channel in the first list would impact the overall network performance. In some aspects, the root AP 110 may utilize a contention graph coloring algorithm to maximize channel reuse in the network.

The first AP 111 may receive, from the root AP 110, a second list of channels that is a subset of the first list of channels (404). The first AP 111 may select a channel from the second list of channels (405), and may provide wireless coverage using the selected channel (406) by, for example, configuring the respective BSS to utilize the selected channel.

FIG. 5A shows an example message flow diagram 500A associated with a channel selection operation. The message flow diagram 500A depicts messages between the first AP 111 and the root AP 110. At 501, the first AP 111 may detect a local channel switch trigger condition. A channel switch trigger condition may be any condition which triggers the first AP 111 to perform a channel selection operation. In some aspects, the first AP 111 may detect the local channel switch trigger condition via the receipt of a channel switch trigger message from the root AP or another AP in the network. In other aspects, the detection of the local channel switch trigger condition may be based on a locally-initiated (at the first AP 111) channel evaluation. In some implementations, the local channel switch trigger condition may be previously configured by the root AP 110. For example, the root AP 110 may send parameters (such as conditions or thresholds) to be used by the first AP 111 to determine when a local channel switch trigger condition has been detected.

Examples of a local channel switch trigger condition may include one or more of:
determining a deterioration of the channel condition for a current channel used by the first AP 111;
determining that the first AP 111 has a load higher than a trigger threshold;
determining co-channel interference on a current channel being used by the first AP 111, where the co-channel interference is impacting channel availability for one or more stations associated with the current channel;
comparing an interference power level with a threshold level; and
comparing a current time with a trigger time configured at the first AP 111.

At 502, the first AP 111 may scan (shown as an arrow 536) a set of channels to obtain any channel condition information that can be observed by scanning the channels. The scanning at 502 may include one or both of passive and active scanning operations. The scanning may include observing signals from other devices or other APs that may be using the channels. Scanning may be used to determine channel signal strength and/or current utilization of the channel.

At 503, the first AP 111 may determine a first list of channels using a first channel selection operation. In some aspects, the first AP 111 may determine the first list of channels based on ranking an effective channel capacity for each channel. The effective channel capacity may be estimated using parameters such as the available airtime of a channel, overlapping BSS airtime, number of devices in the overlapping BSS, signal strength, interference power level, and the physical data rate for devices of the first AP's BSS. The first list of channels may be selected in consideration of a load impact on the other APs if the first AP 111 selects a channel that is used by one or more other APs. In other aspects, the probability of triggering a neighbor AP to switch channels may be considered when selecting the first list of channels (such as described in FIG. 5B).

In some implementations, the first AP 111 may consider an available channel that is already utilized by one or more neighbor APs. For example, a BSS of a neighbor AP may be considered an overlapping BSS (OBSS) if at least a part of the coverage area for the neighbor AP is overlapping the coverage area of the first AP 111. The first AP 111 may determine the effective channel capacity as an estimate of how much of the OBSS airtime the first AP 111 may be expected to utilize via normal airtime contention procedures. To determine the effective channel capacity for a particular channel, the first AP 111 may determine a current available airtime of the particular channel utilized by the OBSS, and determine an additional contention airtime of the particular channel based, at least in part, on a quantity of stations associated with the first AP and the current available airtime (utilized by the OBSS). The first AP 111 may also determine an estimated physical layer transmission data rate for the quantity of stations associated with the first AP, and calculate the effective channel capacity based, at least in part, on the current available airtime, the additional contention airtime, and the estimated physical layer transmission rate.

The first AP 111 sends a message 510 containing the first list of channels to the root AP 110. The message 510 may be any suitable message including, for example, a Channel Switch Request message. At 504, the root AP 110 may distill the first list of channels to determine a second list of channels, which is a subset of the first list of channels. In some implementations, the root AP 110 can reduce/revise the first list of channels based on the root AP's global consideration of the network. In some aspects, the root AP 110 can compare the first list of channels to its own assessment of best channel allocation based on channel condition information collected by the root AP 110. In addition, or in the alternative, the root AP 110 may consider the channel reuse opportunities in the network. In some aspects, the root AP 110 may use a contention graph coloring algorithm to allocate channels so as to maximize channel reuse while using the preferred channels recommended by each of the APs in the network. Examples of the contention graph coloring algorithm may include maximizing channel reuse based on a logical topology of the network, a physical topology of the network, a channel constraint for at least one AP in the network, and/or channel condition information from more than one AP in the network.

In some implementations, the message 510 may also communicate channel constraints. More specifically, in addition to a first list of channels (indicating preferred channels), the message 510 may also include a list of constrained channels (indicating blocked channels that the first AP 111 should not use). The list of constrained channels may include channels (or channel sizes within a frequency band) that should be avoided by the first AP 111. In one example, the list of constrained channels may be included to assist the root AP 110 in allocating channels in the contention graph coloring algorithm. Similarly, a response message 520 transmitted by the root AP 110 may include a list of constrained channels which the root AP 110 forbids or restricts the first AP 111 from selecting. In some implementations, a response message may include a listing of concurrent channels that are being used by the first AP 111. For example, if the first AP 111 is capable of operating on more than one channel (such as a dual-band, dual-concurrent (DBDC) device, or any device with more than one transceiver), the listing of concurrent channels may inform the root AP 110 of the other channels being utilized by the first AP 111.

The root AP 110 sends a message 520 containing the second list of channels to the first AP 111. The message 520 may be any suitable message including, for example, a Channel Switch Response message. At 505, the first AP 111 may select a channel from the second list of channels and utilize the selected channel for a wireless coverage area of the first AP 111. In some implementations, if the first AP 111 knows (from the channel condition information) that it will be utilizing a channel that is currently being used by a neighboring AP, the first AP 111 may inform the neighboring AP before utilizing the channel. Although it may be unavoidable for the first AP 111 to step onto the channel, informing the neighboring AP may provide the neighboring AP with notice about a potential change in the BSS channel capability before the change occurs. The neighboring AP may be in a position to mitigate some of the impact expected from the first AP 111.

In some implementations, the first AP 111 may send a message 530 indicating that the first AP 111 is utilizing the selected channel. The message 530 may be any suitable message including, for example, a Channel Switch Finish message. In response, the root AP 110 may send an acknowledged message 540 to the first AP 111. The message 540 may be any suitable message including, for example, a Channel Switch Finish Response message. The root AP 110 may also inform another AP (such as a neighbor AP of the first AP 111) about the channel selection of the first AP 111 (if the first AP 111 has not already done so).

FIG. 5B shows another example message flow diagram 500B associated with a channel selection operation. At 501, the first AP 111 may detect a local channel switch trigger condition. At 502, the first AP 111 may scan a set of channels to obtain any channel condition information that can be observed by scanning the channels. Unlike the message flow diagram 500A of FIG. 5A, the message flow diagram 500B includes a mechanism for the first AP 111 to obtain more channel condition information about the other APs (such as the second AP 112 and one or more other APs). The first AP 111 may send a query message 511 (such as a Channel Utilization Query message) to the second AP 112 to obtain channel condition information from the second AP 112. The second AP 112 may send a response message 521 to the first AP 111. The response message 521, which may be a Channel Utilization Response message, may include more information than is included in previous Channel Utilization Response messages. In some implementations, the Channel Utilization Response message 521 may be extended to include more channel condition information. A message 521 may describe one or more channel switch trigger conditions of the second AP 112 (referred to as a remote channel switch trigger condition to distinguish from a local channel switch condition of the first AP 111). As another example, the message 521 may also describe one or more other channels observed by the second AP 112, but which the second AP 112 is not currently using. For example, the second AP 112 may include channel condition information that it has obtained by performing a channel scan at the second AP 112.

The first AP 111 may send and receive other messages 513 and 514 to and from other APs in the network as well. By soliciting channel condition information from multiple APs (and particularly from neighboring APs), the first AP 111 can collect a more complete view of the network. As described below, the first AP 111 can utilize the channel condition information obtained from multiple APs to enhance a channel selection algorithm at the first AP 111.

At 503, the first AP 111 may determine a first list of channels using the channel condition information and a first selection operation at the first AP 111. In some implementations, the channel selection operation may also take into account an estimate of the probability of triggering the neighbor AP to switch channels. The first AP 111 may estimate the probability by determining the remote channel switch trigger condition of the neighbor AP, estimating a resulting channel condition at the neighbor AP that would result from the first AP 111 selecting a particular candidate channel from the first list of channels, and comparing the resulting channel condition to the remote channel switch trigger condition. The estimated resulting channel condition may also be based on the channel condition information, and may include one or more of:
a quantity of neighboring APs;
the received signal strength indicators (RSSIs) of neighboring BSS's (including the neighboring AP and associated STAs);
a channel utilization level of the neighboring BSS (overlapping BSS);
a reported collision rate;
channel access delay; and
interference power level.

After determining the first list of channels based on the considerations at 503, the message flow diagram 500B may continue with an exchange of messages 510 and 520 (and optionally messages 530 and 540) in a manner similar to that described with respect to FIG. 5A.

FIG. 5C shows another example message flow diagram 500C associated with a channel selection operation. At 501, the first AP 111 may detect a local channel switch trigger condition. The local channel switch trigger condition may be a result of a message 551 sent from the root AP 110 to the first AP 111. The message 551, which may be a Channel Switch Trigger message or a Channel Switch Allowed message, may be used by the root AP 110 to control stability of the network by forcing or preventing channel selection by a particular AP. In some implementations, the message 551 may prompt the first AP 111 to perform a channel selection operation. At 502, the first AP 111 may scan a set of channels to obtain any channel condition information that can be observed by scanning the channels.

Unlike the message flow diagrams 500B and 500C, the message flow diagram 500C includes another mechanism for the first AP 111 to obtain more channel condition information about the other APs. In some implementations, the root AP 110 may collect the channel condition information from one or more APs in the network, and may provide the collected channel condition information to the first AP 111. The first AP 111 may send a request 552 to the root AP 110. In some aspects, the request 552 may be a Neighbor BSS Channel Condition Query message. If the root AP 110 has previously collected the requested channel condition information, the root AP 110 may send the requested channel condition information in a response 553 to the first AP 111. In some aspects, the response 553 may be a Neighbor BSS Channel Condition Query Response message. If the root AP 110 has not previously collected the requested channel condition information, the root AP 110 may obtain the information before sending the response 553. In some aspects, the root AP 110 may send an acknowledgement message (such as a Neighbor BSS Channel Condition Query Hold message) to the request with an indicator to wait while the root AP 110 collects the requested channel condition information.

In response thereto, the root AP 110 may exchange messages 561 and 562 with the second AP 112 to obtain channel condition information. The root AP 110 may also exchange other messages (not shown) with other APs in the network. After collecting the channel condition information, the root AP 110 sends the collected channel condition information to the first AP 111 in a message 565. In some implementations, the collection of channel condition information may be responsive to a request (as shown in FIG. 5C). In other implementations, the root AP 110 may periodically request channel condition information from the multiple APs in the network so that the information is already available to the root AP 110 when needed for a response to a request. In other implementations, the APs (such as APs 111-116) may periodically report channel condition information to the root AP 110.

After receiving the channel condition information from the root AP 110, the first AP 111 may proceed with the enhanced channel selection. The message flow diagram 500C may proceed with similar message exchanges in a manner similar to that described with respect to FIGS. 5A and 5B.

FIG. 5D shows another example message flow diagram 500D associated with a channel selection operation. Unlike the message flow diagrams 500A-500C, the message flow diagram 500D includes a mechanism for the root AP 110 to manage network stability by controlling when the first AP 111 may perform a channel selection operation.

At 501, the first AP 111 may detect a local channel switch trigger condition. Before proceeding with the channel evaluation or channel selection, the first AP 111 may send a start message 571 to the root AP 110. In some aspects, the start message 571 may be a Channel Switch Start message. The start message 571 may indicate that the first AP 111 has detected a trigger condition and is initiating a channel selection procedure. The root AP 110 may send a hold message 572 to the first AP 111. The hold message 572, which may be a Channel Switch Hold message, may cause the first AP 111 to cease or postpone the channel selection procedure. For example, the root AP 110 may be aware of another AP in the network may have previously initiated a channel switch and may cause the first AP 111 to delay its channel selection until after the other AP completes its channel switch. Thus, the hold message may prevent multiple APs from concurrently performing a channel selection or channel switch, particularly if the multiple APs may have an overlapping coverage area. There may be other reasons that the root AP 110 may send a hold message, such as to promote stability of the network during particular periods of time (such as a peak utilization time period).

The root AP 110 may send a proceed message 573 to the first AP 111. The proceed message 573, which may be a Channel Switch Trigger message or a Channel Switch Allowed message, may instruct the first AP 111 to proceed with the channel selection operation. Alternatively, the proceed message 573 may permit the first AP 111 to proceed with the channel selection operation at time chosen by the first AP 111. In some implementations, the root AP 110 may send the proceed message 573 according to a schedule (such as an off-peak time of day, or off-peak day of week). In some aspects, the root AP 110 may send the proceed message 573 regardless of whether the root AP 110 has previously received a request from the first AP 111 to start the channel selection.

In some implementations, the proceed message 573 may indicate one or more channels pre-selected by the root AP 110, for example, thereby reducing the set of available channels used in the channel selection operation at the first AP 111.

The first AP 111 may proceed with the channel selection operation after receiving the proceed message 573. The message flow diagram 500D may proceed with similar message exchanges in a manner similar to that described with respect to FIGS. 5A-5C.

The channel selection operations described herein may also include one or more stability control techniques. In some implementations, hysteresis may be used in one or more of the comparison operations including, for example, the comparison operations to generate the first list of channels, the comparison operations to generate the second list of channels, the comparison operations to generate the channel condition information, or any combination thereof. In some implementations, a first AP may identify a stability condition associated with one or more neighboring APs and constrain the first list of channels subject to the stability condition of the one or more neighboring APs. In some implementations, a channel selection schedule may be used by one or more APs in the network to stagger channel selection and prevent ping-ponging of the channel selection operations by neighboring APs.

In some implementations, a counter or timer can be used to limit the performance of a channel selection operation by a first AP. For example, the counter or timer may prevent the excessive repetition of channel selection within a time period. In some implementations, a first AP and second AP may exchange results of a channel selection operation and augment the future selections (for the first list of channels) based on the previous result in addition to, or in lieu of, the channel evaluation process.

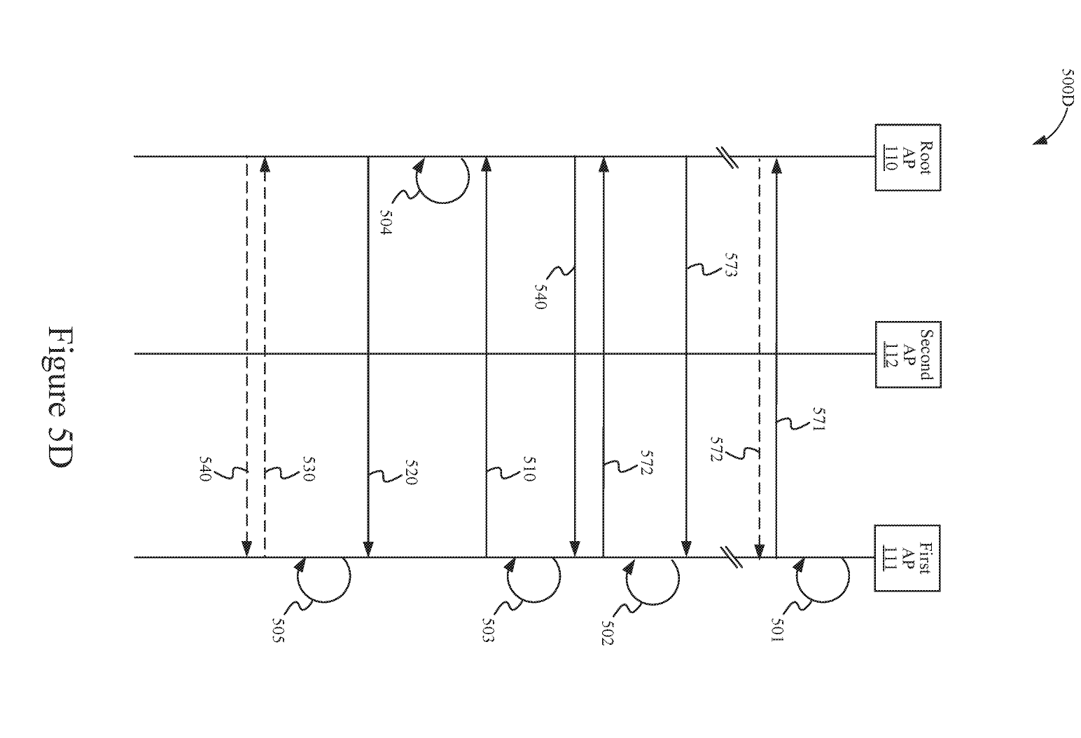

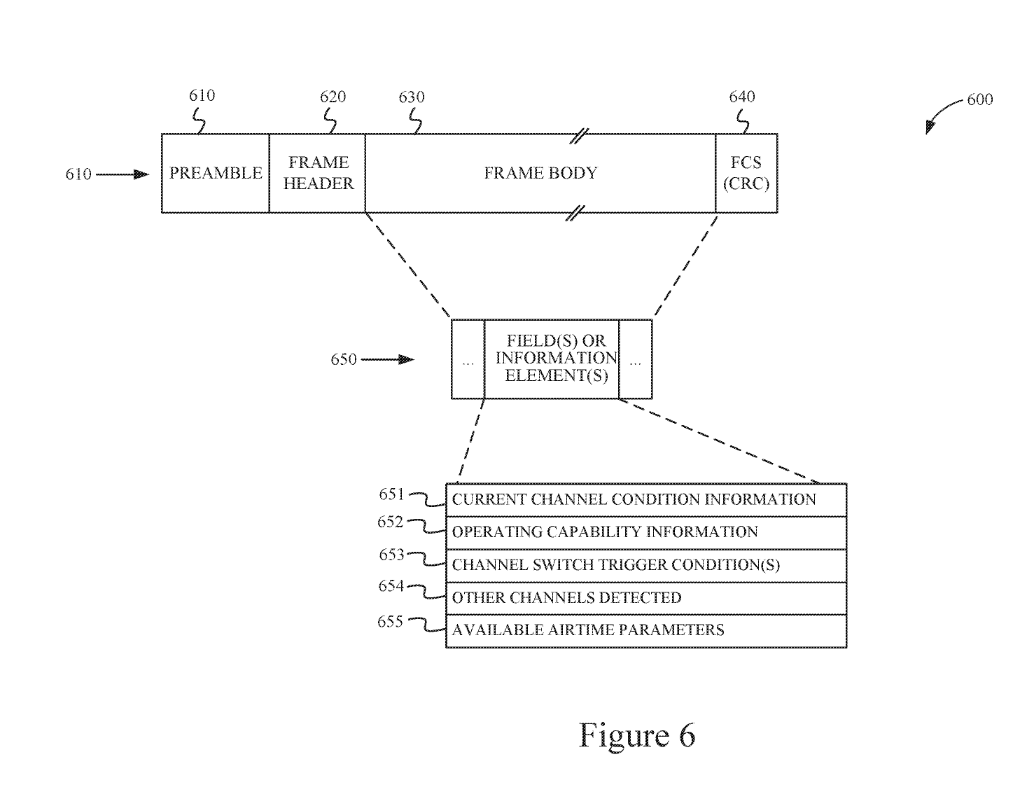

FIG. 6 shows an example data frame 600. The data frame 600 may include a preamble 610, a frame header 620, a frame body 630, and a frame check sequence (FCS) 640. The preamble 610 may include one or more bits to establish synchronization. The frame header 620 may include source and destination network addresses (such as the network address of the sending AP and receiving AP, respectively), the length of data frame, or other frame control information. The frame body 630 may be organized with a message format and may include a variety of fields or information elements 650.

Various fields or information elements may be used to share channel conditions information regarding an AP. For example, the information elements may include current channel condition information 651 (such as channel utilization, number of STAs, contention statistics, channel availability, and the like) for one or more channels being used by the AP. The information elements may include operating capability information 652 (such as PHY capability, MU-MIMO/OFDMA capability, un-usable channels, TX power difference in different channels, RTS/CTS, Integrated Bluetooth coexistence capability, and the like). The information elements may include one or more channel switch trigger condition(s) 653 used by the AP. The information elements may include other channels detected 654 by the AP (such as information obtained by the AP performing a channel scan). The information elements may include available airtime parameters 655 (such as contention statistics for an overlapping BSS, PHY data rates of STS associated with the reporting BSS, interference power level, RSSIs, and the like). The airtime parameters 655 may also include information about channel access delay, collision rate, or any other information which may be usable by a first AP to estimate the effective channel capacity of a channel. In some implementations, an AP may be equipped with more than one radio and may be capable of operating on more than one channel (such as a DBDC device). Each radio, channel, and associated STAs may be considered a separate BSS. Such a multi-BSS AP may send multiple messages, or may send a single message having a collection of the above-described fields or information elements, to describe the multiple BSSs (or “virtual APs”) of the AP.

Referring again to FIG. 1, the MAP controller 135 associated with the root AP 110 may provide a centralized channel selection plan for all of the APs 110-116 in the network. In some implementations, each of the APs 111-116 may determine observable channel condition information (such as described with respect to FIG. 4 and FIGS. 5A-5D), and transmit the observed channel condition information to the root AP 110. The MAP controller 135 may use the channel condition information collected from the APs 111-116 to determine an overall channel selection plan for the network, may assign one or more channels to each of the APs 111-116, and may transmit the channel selection plan (and the channel assignments) to the APs 111-116. In some implementations, the MAP controller 135 may include a memory to store channel allocations for the root AP 110 and the APs 111-116. The stored channel allocations may be used to track which of the APs 110-116 are assigned to each of a number of available channels.

In some implementations, the MAP controller 135 may perform a channel usage estimation operation to determine a usage level (such as the amount of traffic or the overall load) of a channel seen by a selected one of the APs 110-116 as influenced by other nearby APs (such as neighboring APs). In some aspects, the MAP controller 135 may consider the number of neighboring APs and the operating channels of the neighboring APs when estimating channel usage for the selected AP.

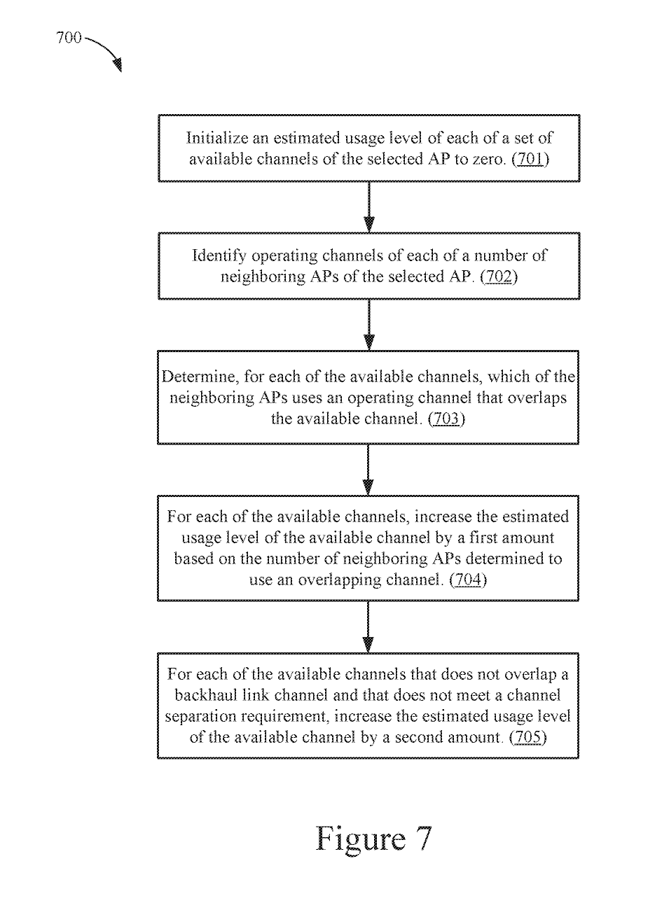

FIG. 7 shows a flow chart depicting an example algorithm for performing a channel usage estimation operation 700. In some implementations, the channel usage estimation operation 700 may be used to estimate, for a selected AP, traffic levels or conditions on a channel resulting from one or more neighboring APs. The estimated traffic levels or conditions resulting from neighboring APs may be indicative of the amount of capacity or resources of the channel that are available for use by the selected AP. In some implementations, the channel usage estimation operation 700 may be performed for every channel available to the selected AP, and the resulting channel usage levels may be used to determine which of the available channels may provide the greatest amount of capacity or resources for the selected AP (such as in light of existing traffic or usage levels of the available channels). Although described herein with respect to the root AP 110, the example channel usage estimation operation 700 may be performed by any suitable AP or wireless device to determine channel usage of a number of channels available for a selected AP (such as one of APs 111-116).

The root AP 110 may initialize an estimated usage level of each of a set of available channels of the selected AP to zero (701), and may identify operating channels of each of a number of neighboring APs of the selected AP (702). The root AP 110 may identify the neighboring APs using any suitable technique or information. In some implementations, the root AP 110 may collect information from the selected AP indicating its neighboring APs. In other implementations, the root AP 110 may store network topology information indicating which of the APs 110-116 may be classified as neighboring APs of the selected AP. For example, referring also to FIG. 1, if the second AP 112 is the selected AP, then the root AP 110 may identify the first AP 111, the third AP 113, the fourth AP 114, the fifth AP 115, and itself as neighboring APs. The root AP 110 may determine the operating channels used by the neighboring APs using any suitable techniques or information. In some implementations, the root AP 110 may determine the operating channels used by each of the neighboring APs based on information provided by the APs 111-116. In other implementations, the root AP 110 may determine the operating channels used by each of the neighboring APs based on one or more scanning operations.

The root AP 110 may determine, for each of the available channels of the selected AP, which of the neighboring APs uses an operating channel that overlaps the available channel (703). The root AP 110 may identify which of the neighboring APs uses an overlapping operating channel using any suitable techniques or information. In some implementations, the root AP 110 may identify all of the neighboring APs that, for each of the available channels, use an overlapping operating channel based on information provided by the APs 111-116. For example, referring also to FIGS. 1 and 2, if the second AP 112 is the selected AP, then the root AP 110 may identify the first AP 111, the third AP 113, the fourth AP 114, fifth AP 115, and itself as neighboring APs using an overlapping channel.

The root AP 110 may, for each of the available channels, increase the estimated usage level of the available channel by a first amount based on the number of neighboring APs determined to use an overlapping channel (704). In some implementations, the first amount may be based on a ratio between a width of an available channel and a width of the overlapping channel of the neighboring AP. For example, referring again to FIG. 2, if the second AP 112 is the selected AP, the available channel is a 40 MHz channel, and the third AP 113 is the neighboring AP using an overlapping 80 MHz channel, then the first amount may be expressed as 40/80=one-half.

The root AP 110 may, for each of the available channels that does not overlap a backhaul link channel and that does not meet a channel separation requirement, increase the estimated usage level of the available channel by a second amount (705). The second amount, which may be denoted as p, may be any suitable value. In some aspects, the value of p may be set to a default value of 1.

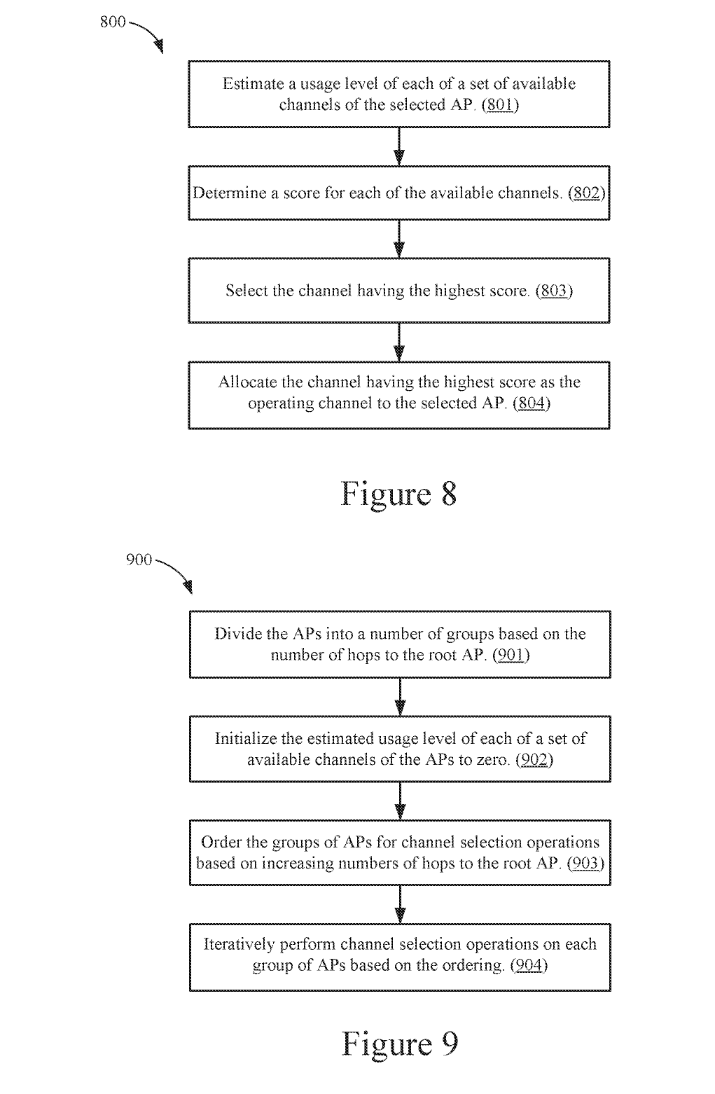

Referring again to FIG. 1, when a satellite AP joins the network, the root AP 110 may select an initial operating channel for the new satellite AP. In some implementations, the root AP 110 may select the initial channel for the new satellite AP without performing a real-time assessment of the channel conditions and channel capacities across the network, for example, as described with respect to FIG. 8.

FIG. 8 shows a flow chart depicting an example algorithm for performing a channel selection operation 800 for an AP. Although described herein with respect to the root AP 110, the example channel selection operation 800 may be performed by any suitable AP or wireless device to determine channel usage for a selected AP (such as one of APs 111-116). Referring again to FIG. 1, if the sixth AP 116 has not yet joined the network, the root AP 110 may (such as by using the MAP controller 135) perform the channel selection operation 800 to select an initial operating channel for the sixth AP 116. Thus, for the example described with respect to FIG. 8, the sixth AP 116 may be the selected AP.

The root AP 110 may estimate a usage level of each of a set of available channels of the selected AP (801). In some implementations, the root AP 110 may use the channel usage estimation operation 700 of FIG. 7 to determine the estimated usage level of each of the set of available channels of the selected AP. In some aspects, the root AP 110 may determine the estimated usage level of every available channel, rather than the set of available channels, because the estimated usage levels of different channels may vary based on which of the channels are used by neighboring APs. In this manner, the root AP 110 may ensure that the estimated channel usage levels of all APs 110-116 in the network are considered before choosing an operating channel for allocation to the selected AP.

The root AP 110 may determine a score for each of the available channels of the selected AP (802). The score for a given channel may be based, at least in part, on the preferred channels of the APs 111-116. In some aspects, each of the APs 111-116 may report, to the root AP 110, preference levels for each of the available channels. In some implementations, the root AP 110 may determine the score (S) of a given channel using the expression:

S=CH_{preference}_{_}ₗₑᵥₑₗ*CH_{bandwidth}/(usage level+1),

where CH_{preference}_{_}ₗₑᵥₑₗ is a preference level indicated by the selected AP for the channel, and CH_{bandwidth} indicates the width or frequency bandwidth of the channel. In some implementations in which the terms CH_{preference}_{_}ₗₑᵥₑₗ and CH_{bandwidth} are vectors, the score (S) may be determined by performing a bitwise multiplication operation on CH_{preference}_{_}ₗₑᵥₑₗ and CH_{bandwidth}, and then dividing the resulting product by a value equal to the determined usage level of the channel plus 1.

The root AP 110 may select the channel having the highest score (803). In some implementations, the scores may be indicative of the available resources for a corresponding channel, for example, where a higher channel score indicates a relatively large amount of available channel resources and a lower channel score indicates a relatively small amount of available channel resources.

The root AP 110 may allocate the channel having the highest score as the operating channel to the selected AP (804). The selected AP may be informed of the allocation of the selected channel as its operating channel using any suitable message or message exchange with the root AP 110 (such as one or more of the message exchanges described with respect to FIGS. 5A-5D). In this manner, the root AP 110 may allocate the channel having the greatest amount of available resources to the selected AP, for example, without generating or implementing a channel selection plan for the entire network. In some implementations, the root AP 110 may consider the impact upon the operating channel due to channel conditions, traffic patterns, and service needs of other wireless devices on the operating channel when allocating the operating channel to the selected AP.

After allocating operating channels to the APs using the example operations 700 and 800 described with respect to FIGS. 7 and 8, the root AP 110 may generate a channel selection plan for the entire network. Referring also to FIG. 1, the network-wide channel selection plan may select operating channels for allocation to each of the APs 110-116 in the network in a manner that considers the impact of all the APs 110-116 upon each of the available channels of the network. The root AP 110 may select the operating channels for allocation to all the APs in the network at certain times of the day, at certain times during the week, at instances in which a change in network topology is detected, or any combination thereof. In some implementations, the root AP 110 may generate a plurality of channel selection plans for each of a number of time periods during the day, may randomly deploy different channel selection plans on different days, and may determine which of the channel selection plans provides the best performance.

For example, on Monday, the root AP 110 may deploy a first channel selection plan and generate a score indicating a performance level of the network based on the first channel selection plan; on Tuesday, the root AP 110 may deploy a second channel selection plan and generate a score indicating a performance level of the network based on the second channel selection plan; and so on. After a scoring a number of the different channel selection plans, the root AP 110 may compare the scores to determine which of the deployed channel selection plans results in the highest network performance. In some implementations, the root AP 110 may select the channel selection plan having the highest score to use for network channel planning during the corresponding time of day. In some aspects, the root AP 110 may assume that traffic patterns during the same time period in different days are similar to each other, for example, so that the root AP 110 may not need to measure actual traffic patterns in real-time; instead, the root AP 110 may correlate each time period to a corresponding traffic pattern, and then stored the traffic patterns in a suitable memory.

In some implementations, the root AP 110 may generate a plurality of different channel selection plans based on channel condition information, traffic patterns, and device needs (or any other suitable factors or network metrics) provided by the APs 111-116, select one of the generated plans for deployment, and allocate operating channels to the APs 111-116 of the network without performing a channel selection plan assessment.

FIG. 9 shows a flow chart depicting an example algorithm for performing a channel selection operation 900 for a network without a channel selection plan assessment. Although described herein with respect to the root AP 110, the example channel selection operation 900 may be performed by any suitable AP or wireless device to select channels for all of the APs in a network (such as the satellite APs 111-116 of FIG. 1).

The root AP 110 may divide the satellite APs of the entire network into a number of groups based on the number of hops to the root AP 110 (901). For example, referring also to FIG. 1, the first AP 111, the second AP 112, and the fourth AP 114 are each separated from the root AP 110 by 1 hop, and may therefore be grouped together in a first group having a hop count=1. The third AP 113 and the fifth 115 are each separated from the root AP 110 by 2 hops, and may therefore be grouped together in a second group having a hop count=2. The sixth AP 116 is separated from the root AP 110 by 3 hops, and may therefore be grouped in a third group having a hop count=3.

The root AP 110 may initialize the estimated usage level of each of a set of available channels of the APs 111-116 to zero (902), and may order the groups of APs for channel selection operations based on a number of hops to the root AP 110 (903). For example, the groups of APs may be ordered based on increasing numbers of hops to the root AP 110, for example, so that the APs in the first group having a hop count=1 are processed first, the APs in the second group having a hop count=2 are processed second, and the APs in the third group having a hop count=3 are processed third. Performing channel selection operations for groups of APs that are closer to the root AP 110 before performing channel selection operations for groups of APs that are further from the root AP 110 may optimize channel planning operations, for example, because groups of APs having fewer numbers of hops to the root AP 110 typically have a larger impact on network performance than groups of APs having greater numbers of hops to the root AP 110. For example, referring again to FIG. 2, while all communications originating from client devices associated with the sixth AP 116 are routed or “hopped” to the root AP 110 through the fourth AP 114 and the fifth AP 115, communications originating from client devices associated with the fifth AP 115 are routed or “hopped” to the root AP 110 through only the fourth AP 114 (which also routes communications originating from its associated client devices to the root AP 110).

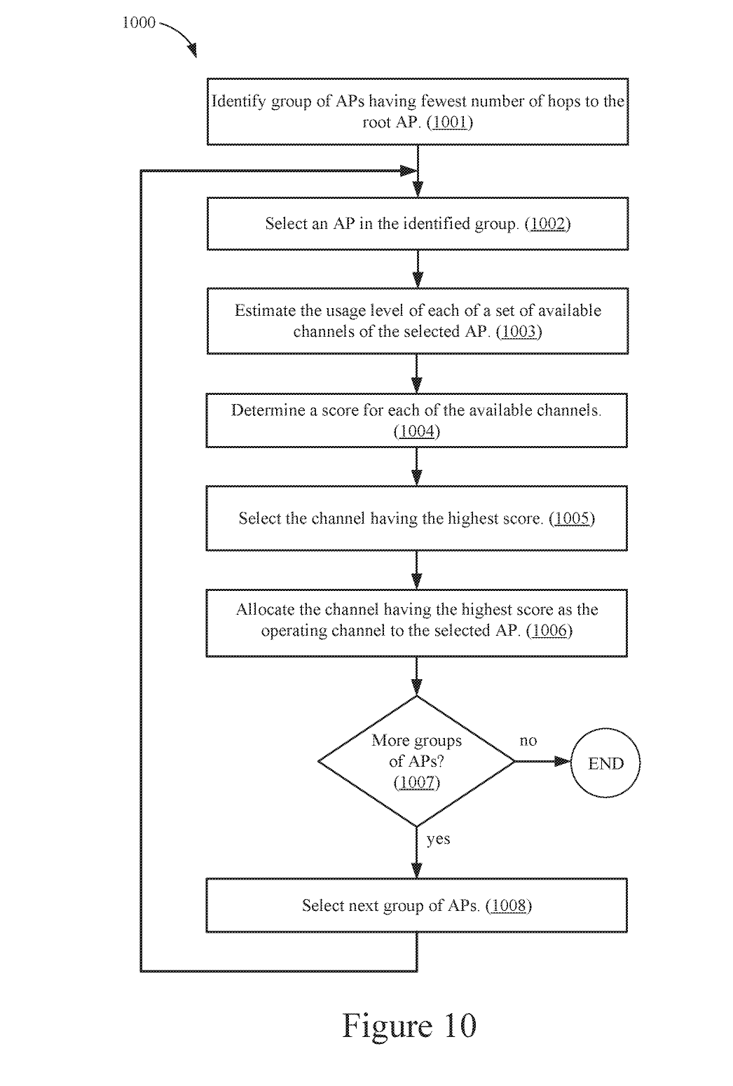

The root AP 110 may iteratively perform channel selection operations on each group of APs based on the ordering (904). In some implementations, the root AP 110 may select any of the APs within a particular group to begin channel selection operations. The root AP 110 may perform channel selection operations on a particular group of APs as described with respect to FIG. 10.

FIG. 10 shows a flow chart depicting an example algorithm for performing an iterative channel selection operation 1000. For example, the iterative channel selection operation 1000 can include the application of channel selection operations to groups of APs ordered according to the example channel selection operation 900 of FIG. 9. Although described herein with respect to the root AP 110, the example operation 1000 may be performed by any suitable AP or wireless device to determine channel usage for a selected AP (such as one of APs 111-116).

The root AP 110 may identify the group of APs having the fewest number of hops to the root AP 110 (1001), and may select one of the APs within the identified group of APs (1002). The root AP 110 may estimate the usage level of each of a set of available channels of the selected AP (1003). In some implementations, the root AP 110 may use the channel usage estimation operation 700 of FIG. 7 to determine the estimated usage level of each of the set of available channels of the selected AP. In some aspects, the root AP 110 may determine the estimated usage level of all available channels of the selected AP, rather than the set of available channels, because the usage levels of different channels may vary based on which of the channels are used by neighboring APs. In this manner, the root AP 110 may ensure that the estimated channel usage of all APs 110-116 in the network are considered before choosing an operating channel for allocation to the selected AP.

The root AP 110 may determine a score for each of the available channels of the selected AP (1004). The score for a given channel may be based, at least in part, on the preferred channels of the APs 111-116. In some aspects, each of the APs 111-116 may report, to the root AP 110, preference levels for each of the set of available channels. In some implementations, the root AP 110 may determine the score (S) of a given channel using the expression:

S=CH_{preference}_{_}ₗₑᵥₑₗ*CH_{bandwidth}/(usage level+1),

where CH_{preference}_{_}ₗₑᵥₑₗ is a preference level indicated by the selected AP for the channel, and CH_{bandwidth} indicates the width or frequency bandwidth of the channel. In some implementations in which the terms CH_{preference}_{_}ₗₑᵥₑₗ and CH_{bandwidth} are vectors, the score (S) may be determined by performing a bitwise multiplication operation on CH_{preference}_{_}ₗₑᵥₑₗ and CH_{bandwidth}, and then dividing the resulting product by a value equal to the determined usage level of the channel plus 1.

The root AP 110 may select the channel having the highest score (1005). In some implementations, the scores may be indicative of the available resources for a corresponding channel, for example, where a higher channel score indicates a relatively large amount of available channel resources and a lower channel score indicates a relatively small amount of available channel resources.

The root AP 110 may allocate the channel having the highest score as the operating channel to the selected AP (1006). The selected AP may be informed of the allocation of the selected channel as its operating channel using any suitable message or message exchange with the root AP 110 (such as one or more of the message exchanges described with respect to FIGS. 5A-5D). In this manner, the root AP 110 may allocate the channel having the greatest amount of available resources to the selected AP. In some implementations, the root AP 110 may consider the impact upon the operating channel due to channel conditions, traffic patterns, and service needs of other wireless devices on the operating channel when allocating an operating channel to the selected AP.

If there are additional groups of APs, as tested at 1007, the root AP 110 selects the next group of APs (1008), and the operation 1000 continues at 1002. Otherwise, the operation 1000 ends.

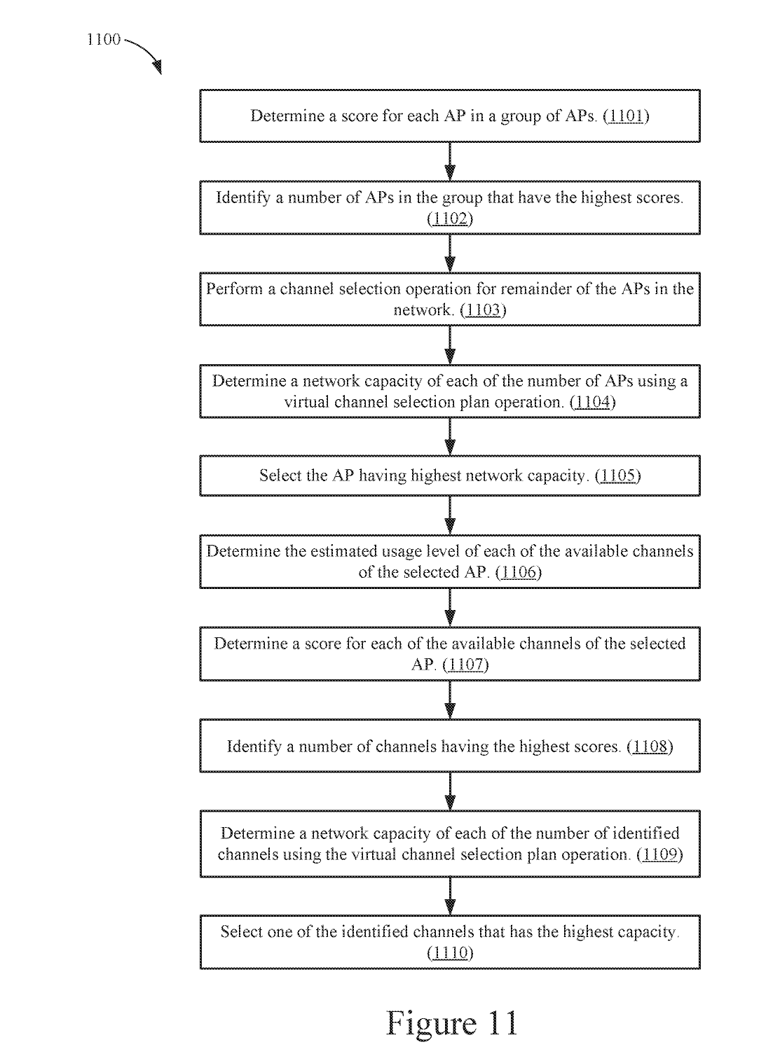

The example operation 1000 of FIG. 10 may be used to perform a channel selection operation without a virtual channel selection plan assessment. In other implementations, the root AP 110 may employ a virtual channel selection plan assessment to estimate network traffic patterns or channel usage levels for each of the channel selection plans, for example, as described with respect to FIG. 11.

FIG. 11 shows a flow chart depicting an example algorithm for performing a channel selection operation 1100 for a network with a virtual channel selection plan assessment. For example, the channel selection operation 1100 can include the application of channel selection operations to groups of APs using a virtual channel selection plan assessment. Although described herein with respect to the root AP 110, the example operation 1100 may be performed by any suitable AP or wireless device to perform a channel selection operation for a network. The channel selection operation 1100 of FIG. 11 is similar to the iterative channel selection operation 1000 of FIG. 10, except that the root AP 110 generates a plurality of candidate channel selection plans for the network in the channel selection operation 1100. Referring also to FIG. 9, the example channel selection operation 1100 may be one implementation of the iterative performance of the channel selection operations at 904 of the channel selection operation 900.

The root AP 110 may determine a score for each satellite AP in a group of APs (1101). In some implementations, the root AP 110 may determine the score (S) of a respective AP using the expression:

S=N_{agents}*N_{clients}_{_}_{down},

where N_{agents} is the number of neighboring APs relative to the respective AP, and N_{clients}_{_}_{down} is the number of downstream client devices serviced by the respective AP. In some implementations in which the terms CH_{preference}_{_}ₗₑᵥₑₗ and CH_{bandwidth} are vectors, the score (S) may be determined by performing a bitwise multiplication operation on CH_{preference}_{_}ₗₑᵥₑₗ and CH_{bandwidth}, and then dividing the resulting product by a value equal to the determined usage level of the channel plus 1.

The root AP 110 may identify a number of satellite APs (denoted as N_{agent}) in the group that have the highest scores (1102). In some aspects, the root AP 110 may use a default value of N_{agent}=3).

The root AP 110 may perform a channel selection operation for the remainder of the APs in the network (1103). In some implementations, the root AP 110 may employ the channel selection operation 900 of FIG. 9. In some aspects, the root AP 110 may perform the channel selection operation for each of the number N_{agent} of satellite APs in the group.

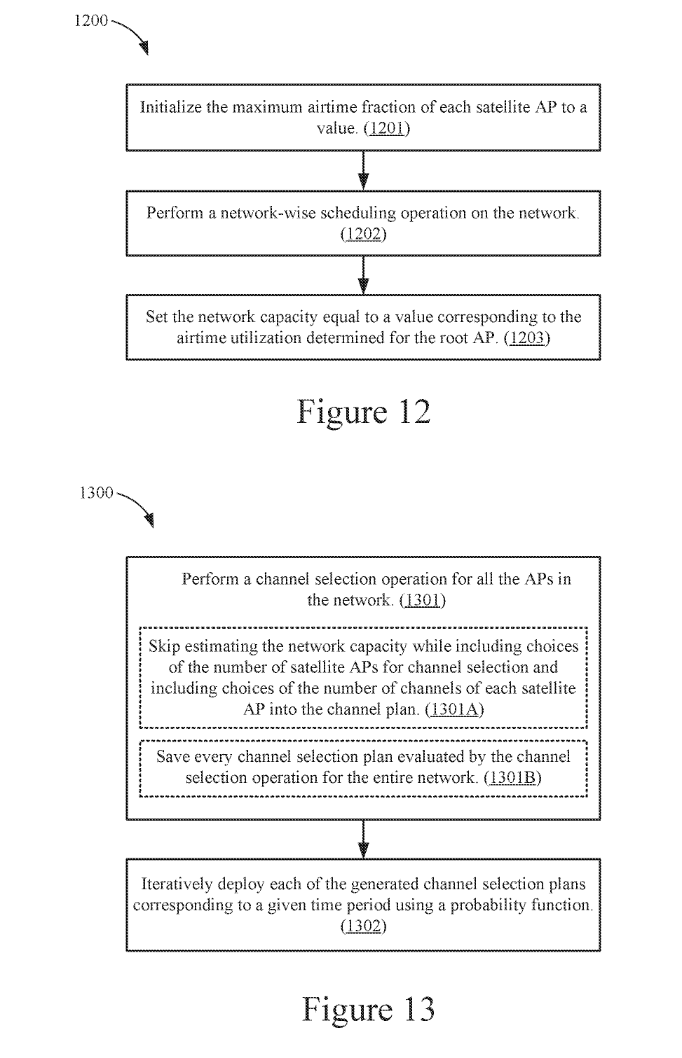

The root AP 110 may determine a network capacity of each of the number of satellite APs using a virtual channel selection plan operation (1104). An example virtual channel selection plan operation is described in more detail with respect to FIG. 12.

The root AP 110 may select the AP having the highest network capacity (1105), and may determine the estimated usage level of each of the available channels of the selected satellite AP(1106). In some implementations, the root AP 110 may use the channel usage estimation operation 700 described with respect to FIG. 7 to determine the estimated usage level of each of the available channels of the selected AP.

The root AP 110 may then determine a score for each of the available channels of the selected satellite AP (1107). In some implementations, the root AP 110 may calculate the score for a channel using the expression:

S=CH_{preference}_{_}ₗₑᵥₑₗ*CH_{bandwidth}/(usage level+1),

where CH_{preference}_{_}ₗₑᵥₑₗ is a preference level indicated by the selected satellite AP for the channel, and CH_{bandwidth} indicates the width or frequency bandwidth of the channel. In some implementations in which the terms CH_{preference}_{_}ₗₑᵥₑₗ and CH_{bandwidth} are vectors, the score (S) may be determined by performing a bitwise multiplication operation on CH_{preference}_{_}ₗₑᵥₑₗ and CH_{bandwidth}, and then dividing the resulting product by a value equal to the determined usage level of the channel plus 1.

The root AP 110 may identify a number of channels (denoted as N_{channel}) having the highest scores (1108). In some aspects, the root AP 110 may use a default value of N_{channel}=3.

The root AP 110 may determine a network capacity of each of the number of identified channels using the virtual channel selection plan operation (1109), and may select one of the identified channels that has the highest capacity (1110). The root AP 110 may repeat this process until operating channels have been allocated to all of the APs in the network.

FIG. 12 shows a flow chart depicting an example algorithm for performing a virtual channel selection plan assessment 1200. Although described herein with respect to the root AP 110, the example virtual channel selection plan assessment operation 1200 may be performed by any suitable AP or wireless. The virtual channel selection plan assessment operation 1200 may be used by the root AP 110 to select operating channels for all the APs in a network using simulated traffic patterns and loads. In some implementations, the virtual channel selection plan assessment operation 1200 may be a presumptive channel selection plan for all APs in the network, and may consider neighboring APs of each satellite AP in the network, associated APs as client devices of each satellite AP in the network, the data rates of the STAs associated with each of the satellite APs in the network, or any combination thereof.

The root AP 110 may initialize the maximum airtime fraction of each satellite AP to a value (1201). In some implementations, the root AP 110 may use the following expression:

Tₐᵢᵣₜᵢₘₑ=P_{AP}_{_}_{agent}/(P_{AP}_{_}_{neighbor}+P_{AP}_{_}_{agent}),

where P_{AP}_{_}_{agent} indicates the downstream client population of the satellite AP, and P_{AP}_{_}_{neighbor} indicates the downstream client populations of neighboring satellite APs sharing the same channel.

The root AP 110 may perform a network-wise scheduling operation on the network (1202). In some implementations, the root AP 110 may assign airtime to each satellite AP based on traffic demands of their client devices, for example, so that the root AP 110 can estimate the capacities of the satellite APs.

The root AP 110 may set the network capacity equal to a value corresponding to the airtime utilization determined for the root AP 110 (1203). In some implementations, the root AP 110 may perform a simulation to determine the airtime utilization for the root AP 110. In some aspects, the root AP 110 may use envelope calculation to determine the airtime utilization. In other aspects, the root AP 110 may perform a simulation to determine the airtime utilization, and may then select a candidate channel selection plan that provides the highest network capacity.

In other implementations, the root AP 110 may use a real-time channel selection plan assessment. The real-time channel selection plan assessment may use a number of actual network key performance indicators (KPIs) to generate a score. In some implementations, the scores of a plurality of candidate channel selection plans may be compared with each other for corresponding time periods in a day. The root AP 110 may deploy different candidate channel selection plans on different days, and then compare the overall network performance for each of the deployed candidate channel selection plans. The scores of candidate channel selection plans that provide the best network performance may be incrementally increased over time, and the scores of candidate channel selection plans that provide the worst network performance may be incrementally decreased over time. In this manner, candidate channel selection plans that provide the best network performance may be more likely to be deployed in the network than candidate channel selection plans that provide the worst network performance.

In some implementations, the real-time channel selection plan assessment may include or consider one or more of the following parameters:
Throughput histogram for every client;
Latency histogram for every client;
Delay factor histogram for every client; and
Packet dropping rate histogram for every client.

In addition, or in the alternative, the real-time channel selection plan assessment may generate a score for each of a plurality of candidate channel selection plans using one or more of the following KPIs:
Peak total network throughput/root-AP data rate limit (Rₘₐₓ/γ);
Average total network throughput/root-AP data rate limit (Rₐᵥₑ/γ);
10 percentile client throughput/individual Multi-AP data rate limit (R₁₀ₚ/γ);
Expected maximum latency for VoIP traffic/90 percentile latency for VoIP traffic (D_{VoIP}/d_{90pVoIP});
Expected maximum packet dropping rate for VoIP traffic/90% packet dropping rate for VoIP traffic (PB_{VoIP}/pb_{90pVoIP});
Expected maximum latency for VoW traffic/90 percentile latency for VoW traffic (D_{VOW}/d_{90pVOW});
Expected maximum delay factor for VoW traffic/90 percentile delay factor for VoW traffic (H_{VOW}/h_{90pVOW}); and
Expected maximum packet dropping rate for VoW traffic/90% packet dropping rate for VoW traffic (PB_{VOW}/pb_{90pVOW}).

In some implementations, the score for each channel selection plan may be a weighted sum of a logarithm function of each of the above-described KPIs, which may be expressed as Σ_{f}α_{f} log(1+f), where f represents any of the above KPIs. In this manner, channel selection plans with lower performance may have lower probabilities of being selected for deployment by the root AP 110.

FIG. 13 shows a flow chart depicting an example algorithm for performing a channel selection operation 1300 with virtual channel selection plan assessment and real-time channel selection plan assessment. Although described herein with respect to the root AP 110, the example operation 1300 may be performed by any suitable AP or wireless device to determine channel usage for a selected AP (such as one of APs 111-116).

The root AP 110 performs a channel selection operation for all the APs in the network (1301). In some implementations, the root AP 110 may skip estimating the network capacity while including choices of the number N_{agent} of satellite APs for channel selection and including choices of the number of channels N_{channel} of each satellite AP into the channel plan (1301A). The root AP 110 may also save every channel selection plan evaluated by the channel selection operation for the entire network (1301B).

The root AP 110 may iteratively deploy each of the generated channel selection plans corresponding to a given time period using a probability function (1302). In some implementations, the probability function may be a product of the real-time channel selection plan assessment scores (1302).

In some implementations, the root AP 110 may limit the total number of channels used in the network. In some aspects, when the number of channels used in a network including multiple APs is large, a particular AP may need to request its client devices to scan a larger number of channels in the for AP steering operations, which may subsequently cause the AP steering procedure to run out of time when a client device needs to be quickly steered to another AP (such as due to channel conditions). Limiting the total number of channels used in such a network may reduce such risk. However, the consequence of a potential prolonged AP steering operations may be mitigated since a client device may be steered to another AP (such as by using its own roaming techniques). Hence, the drawback of limiting the total number of channels may outweigh its benefit in reducing the duration of AP steering operations, for example, when the network needs additional capacity.

The option to limit the total number of channels used in an MAP network is described below:
The map controller 135 is configured with the maximum number of channels for its network.
Keep any channel that is inoperable or the least preferred channel for some satellite APs out of the set of available channels for the network.
Upon selecting a channel for a satellite AP when performing the channel selection operation for the satellite AP or the channel selection operation for the entire network, check the number of channels selected for satellite APs whose channel selections are already finalized in the algorithm run. If that number is already equal to the maximum number of channels for its network, limit the available channels for that satellite AP to the operating channels of those satellite APs whose channel selections are already finalized in the algorithm run.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

What is claimed is:

1. A method of performing a channel selection operation for a selected access point (AP), comprising:
estimating a usage level of each of a set of available channels of the selected AP;
determining a score for each of the available channels;
selecting the channel having the highest score; and
allocating the channel having the highest score as the operating channel to the selected AP.

2. The method of claim 1, wherein the score for a respective channel is based on at least one of a preference level of the respective channel, a bandwidth of the respective channel, or the estimated usage level of the respective channel.

3. The method of claim 2, wherein the preference level is indicated by the selected AP.

4. The method of claim 1, wherein the score for a respective channel is based on a bitwise multiplication of a first vector indicating a preference level of the respective channel and a second vector indicating a frequency bandwidth of the respective channel.

5. The method of claim 1, wherein estimating the usage level of a respective channel comprises:
initializing the estimated usage level of the respective channel to zero;
identifying operating channels of each of a number of neighboring APs of the selected AP;
determining which of the neighboring APs uses an operating channel that overlaps the respective channel; and
increasing the estimated usage level of the respective channel by a first amount based on the number of neighboring APs determined to use an overlapping channel.

6. The method of claim 5, wherein the first amount is based on a ratio of a bandwidth of the respective channel and a bandwidth of the overlapping channel.

7. The method of claim 5, further comprising:
increasing the estimated usage level by a second amount if the respective channel does not overlap with a backhaul link channel and does not meet a channel separation requirement.

8. A method of performing a channel selection operation for a network including a root access point (AP) and a plurality of satellite APs, comprising:
dividing the satellite APs into a number of groups based on a number of hops to the root AP;
initializing an estimated usage level of each of a set of available channels of the satellite APs to zero;
ordering the groups of satellite APs based on increasing numbers of hops to the root AP; and
iteratively performing a channel selection operation on each group of satellite APs based on the ordering.

9. The method of claim 8, wherein the channel selection operation is performed on groups of satellite APs having fewer numbers of hops to the root AP before groups of satellite APs having greater numbers of hops to the root AP.

10. The method of claim 8, wherein iteratively performing the channel selection operation comprises:
identifying the group of satellite APs having the fewest number of hops to the root AP;
selecting one of the satellite APs within the identified group;
determining an estimated usage level of each of the available channels of the selected satellite AP;
determining a score for each of the available channels of the selected satellite AP;
selecting the channel having the highest score; and
allocating the channel having the highest score as the operating channel of the selected satellite AP.

11. The method of claim 10, wherein the score for a respective channel is based on at least one of a preference level of the respective channel, a bandwidth of the respective channel, or the estimated usage level of the respective channel.

12. The method of claim 11, wherein the preference level is indicated by the selected satellite AP.

13. The method of claim 8, further comprising:
performing a virtual channel selection plan assessment for the network.

14. The method of claim 13, wherein performing the virtual channel selection plan assessment comprises:
initializing a maximum airtime fraction of each satellite AP to a value;
performing a network-wise scheduling operation that assigns airtime to each satellite AP based on traffic demands of their client devices; and
setting a network capacity equal to a value corresponding to an airtime utilization determined for the root AP.

15. A method of performing a channel selection operation for a network including a root access point (AP) and a plurality of satellite APs, comprising:
determining a score for each of the satellite APs in a group of APs;
identifying a number of the satellite APs in the group that have the highest scores;
performing a channel selection operation for the remainder of the APs in the network;
determining a network capacity of each of the number of satellite APs using a virtual channel selection plan operation;
selecting the satellite AP having the highest network capacity;
determining an estimated usage level of each of the available channels of the selected satellite AP;
determining a score for each of the available channels of the selected satellite AP;
identifying a number of channels having the highest scores; and
determining a network capacity of each of the number of identified channels using the virtual channel selection plan operation.

16. The method of claim 15, wherein performing the virtual channel selection plan assessment comprises:
initializing a maximum airtime fraction of each satellite AP to a value;
performing a network-wise scheduling operation that assigns airtime to each satellite AP based on traffic demands of their client devices; and
setting a network capacity equal to a value corresponding to an airtime utilization determined for the root AP.

17. The method of claim 15, further comprising:
selecting one of the identified channels that has the highest capacity.

18. The method of claim 15, wherein the score for a respective one of the satellite APs is based on the number of neighboring APs relative to the respective satellite AP and the number of downstream client devices serviced by the respective satellite AP.

19. A root access point (AP) for performing a channel selection operation for a network including a plurality of satellite APs, comprising:
one or more processors; and
a memory storing instructions that, when executed by the one or more processors, cause the root AP to:
divide the satellite APs into a number of groups based on a number of hops to the root AP;
initialize an estimated usage level of each of a set of available channels of the satellite APs to zero;
order the groups of satellite APs based on increasing numbers of hops to the root AP; and
iteratively perform a channel selection operation on each group of satellite APs based on the ordering.

20. The root AP of claim 19, wherein the channel selection operation is performed on groups of satellite APs having fewer numbers of hops to the root AP before groups of satellite APs having greater numbers of hops to the root AP.

21. The root AP of claim 19, wherein execution of the instructions to iteratively perform the channel selection operation causes the root AP to:
identify the group of satellite APs having the fewest number of hops to the root AP;
select one of the satellite APs within the identified group;
determine an estimated usage level of each of the available channels of the selected satellite AP;
determine a score for each of the available channels of the selected satellite AP;
select the channel having the highest score; and
allocate the channel having the highest score as the operating channel of the selected satellite AP.

22. The root AP of claim 21, wherein the score for a respective channel is based on at least one of a preference level of the respective channel, a bandwidth of the respective channel, or the estimated usage level of the respective channel.

23. The root AP of claim 22, wherein the preference level is indicated by the selected satellite AP.

24. The root AP of claim 19, wherein execution of the instructions further causes the root AP to:
perform a virtual channel selection plan assessment for the network.

25. The root AP of claim 24, wherein execution of the instructions to perform the virtual channel selection plan assessment causes the root AP to:
initialize a maximum airtime fraction of each satellite AP to a value;
perform a network-wise scheduling operation that assigns airtime to each satellite AP based on traffic demands of their client devices; and
set a network capacity equal to a value corresponding to an airtime utilization determined for the root AP.

26. The root AP of claim 19, wherein execution of the instructions to determine the estimated usage level of a respective channel causes the root AP to:
estimate a usage level of each of a set of available channels of every channel available to the selected AP;
determine a score for each of the available channels of the selected AP;
select the channel having the highest score; and
allocate the channel having the highest score as the operating channel to the selected AP.

27. The root AP of claim 26, wherein the score for a respective channel is based on at least one of a preference level of the respective channel, a bandwidth of the respective channel, or the estimated usage level of the respective channel.

28. The root AP of claim 27, wherein the preference level is indicated by the selected AP.

29. The root AP of claim 26, wherein the score for a respective channel is based on a bitwise multiplication of a first vector indicating a preference level of the respective channel and a second vector indicating a frequency bandwidth of the respective channel.

30. The root AP of claim 19, wherein execution of the instructions for estimating the usage level of a respective channel causes the root AP to:
initialize the estimated usage level of the respective channel to zero;
identify operating channels of each of a number of neighboring APs of the selected AP;
determine which of the neighboring APs uses an operating channel that overlaps the respective channel; and
increase the estimated usage level of the respective channel by a first amount based on the number of neighboring APs determined to use an overlapping channel.
